(19) United States
(12) Patent Application Publication
(10) Pub. No.: US 2015/0227090 A1
(43) Pub. Date: Aug. 13, 2015

(54) ELECTROCONDUCTIVE RESIN BELT, METHOD OF PREPARING THE SAME, AND IMAGE FORMING APPARATUS HAVING THE SAME

(71) Applicants: Sumio Kamoi, Tokyo (JP); Takashi Tanaka, Kanagawa (JP); Yumiko Hayashi, Kanagawa (JP); Tomoko Satoh, Kanagawa (JP); Takuya Kohda, Kanagawa (JP)

(72) Inventors: Sumio Kamoi, Tokyo (JP); Takashi Tanaka, Kanagawa (JP); Yumiko Hayashi, Kanagawa (JP); Tomoko Satoh, Kanagawa (JP); Takuya Kohda, Kanagawa (JP)

(73) Assignee: RICOH COMPANY, LTD., Tokyo (JP)

(21) Appl. No.: 14/619,206

(22) Filed: Feb. 11, 2015

(30) Foreign Application Priority Data
Feb. 12, 2014 (JP) 2014-024348
Jan. 8, 2015 (JP) 2015-002551

(51) Int. Cl. H01B 1/24; G03G 15/16; B28B 1/14

(52) U.S. Cl. CPC G03G 15/1615; G03G 15/162; B29C 35/16; B29L 2029/00

(57) ABSTRACT

An electroconductive resin belt having a flame resistance of VTM-0 in UL94 standard when having a thickness of from 50 to 150 μm includes a first resin selected from the group consisting of polyetherimide-siloxane block copolymer, polyphenylene sulfide and polyimide; a second resin selected from the group consisting of polyetherimide, polyether sulfone, polyester, aliphatic polyamide, polyetherimide-siloxane block copolymer and polyamideimide; carbon as a first conductant; and at least one second conductant selected from the group consisting of particulate Al-doped ZnO, particulate Ga-doped ZnO, particulate Sb-doped SnO₂, particulate In-doped SnO₂, particulate P-doped SnO₂ and the group consisting of metal oxides coated with any one of the second conductant group. The first resin forms a continuous phase, the second resin forms a dispersion phase, the carbon is unevenly distributed in the dispersion phase or an arc therearound, the second conductant is present in both of the dispersion phase and the continuous phase.

### CROSS-REFERENCE TO RELATED APPLICATIONS

This patent application is based on and claims priority pursuant to 35 U.S.C. §119 to Japanese Patent Applications Nos. 2014-024348 and 2015-002551, filed on Feb. 12, 2014 and Jan. 8, 2015, respectively in the Japan Patent Office, the entire disclosure of which is hereby incorporated by reference herein.

### BACKGROUND

1. Technical Field

The present invention relates to an electroconductive seamless belt such as an intermediate transfer belt, a conveyance belt, a transfer belt, a fixing belt and a developing belt used in an electrophotographic or electrostatic image forming apparatus such as a copier, a laser beam printer, a facsimile, etc.

2. Description of the Related Art

An intermediate transfer belt used for an electrophotographic image forming apparatus requires uniformity in electric resistance, surface smoothness, mechanical properties (high flexure, high elasticity, high ductility), and high size accuracy (film thickness, and peripheral length). Moreover, it is recently required for parts to have flame resistance, and it is necessary to satisfy VTM-0 of flame resistance standard of UL94, which is UL Standard (Under Writers Laboratories Inc. Standard).

In addition, the intermediate transfer belt is required to have functionalities such as transferability, prevention of abnormal images, and stability of the surfaceness.

As for a material satisfying the aforementioned requirements, a double-layered belt formed by coating a varnish including fluorine and siloxane to a material in which electrical conductivity is imparted to a thermoset polyimide resin or polyamide imide resin, has been used.

As for a method for preparing a heat resistant endless belt (seamless belt) using a polyimide resin, a method containing cast molding a polyimide vanish on a circumferential surface of a cylinder composed of a metal, followed by heating the cast-molded polyimide varnish to proceed imidization, to thereby form an endless belt of polyimide is disclosed. This proposed method however has problems that a material cost is high, and a process of imidization takes a long time, which leads to a high production cost. Moreover, the proposed method requires a new metal mold every time a size is changed, and therefore a plurality of metal molds need to be prepared to thereby increase an initial cost.

In order to form a double-layered belt, a varnish including fluorine and siloxane needs to be coated on a substrate (thickness of from 0.5 10 μm) by spray coating or blade coating, which increases the number of processes and cost.

The intermediate transfer belt is an expensive part compared to other parts in an electrophotographic image forming apparatus, and therefore a cost-down of the intermediate transfer belt is desired. The intermediate transfer belt can be prepared at an extremely low cost, if it can be prepared by extrusion molding or inflation molding using a thermoplastic resin in order to reduce a cost of the intermediate transfer belt.

As for a flame resistant thermoplastic resin, moreover, there are, for example, a fluororesin such as polyvinylidene fluoride (PVDF), a polyacrylate resin, a polyphenylene sulfide (PPS) resin, a polyether sulfone (PES) resin, a polysulfone (PS) resin, a polyether imide (PEI) resin, a polyether ether ketone (PEEK) resin, thermoplastic polyimide (TPI), and a liquid crystal polymer (LCP).

Eve when any of the materials are used, a single layer does not satisfy sufficient mechanical properties (mentioned later) and the functionalities such as transferability and stability of the surfaceness.

Japanese published unexamined application No. JP-2011-26584-A discloses an electroconductive thermoplastic resin film or sheet including a thermoplastic resin (A), a thermoplastic resin (B) which is a block copolymer including a thermoplastic resin block unit which is the same kind of the thermoplastic resin (A) and a siloxane block unit and electroconductive carbon black. However, distributions of a first conductant and a second conductant are not disclosed at all. In the present invention, a first conductant carbon is unevenly distributed in a dispersion phase of a second group polymer, and a second conductant is present in both of the dispersion phase and a continuous phase.

Japanese published unexamined application No. JP-2012-46721-A discloses polymer alloys PPS and siloxane-modified PEI similar to those of the present invention. They are not electroconductive belts, though. It is known that conductivity-imparting agents such as carbon, metals, metal oxides and ionic conductants are blended to form electroconductive belts. Electrical properties and glossiness required for the belt need carbon and conductant (first group or second group) of the present invention. Carbon is known to be unevenly distributed when polymer-alloyed, and needs blending in consideration of the uneven distribution, which is not referred to in this disclosure. Hereinafter, some related patents follow, but almost all of them are disclosures of electroconductive resin belts (compositions) having no particular flame resistance. Almost all the materials therein are unusable when flame resistance is needed. There are many materials to obtain desired mechanical and electrical properties unless flame resistance is needed. The present invention discloses combinations of specific materials satisfying flame resistance, mechanical properties, electrical properties, surface glossiness, resistivity controllability, prevention of abnormal images and forming stability at the same time.

Japanese published unexamined application No. JP-2001-51524-A discloses an intermediate transferer formed of at least a thermoplastic polyimide resin, having good durability, no defective transfer of a microscopic part of images, and producing images having uniform quality. The thermoplastic polyimide is different from the semi-aromatic crystalline thermoplastic polyimide of the present invention, which does solve the problems thereof.

Japanese Patent No. JP-3237715-B2 (Japanese published unexamined application No. JP-H05-031781-A) discloses extruding a thermoplastic polyimide resin including a water content not greater than 30 ppm to form a tube-shaped film having precise sizes and thickness, which increases cost due to the specific extruder.

Japanese published unexamined application No. JP-H11-170389-A closest to the present invention discloses a method of preparing a seamless belt having good tensile elasticity while maintaining continuous molding with a resin composition including a thermoplastic polyimide resin and an electroconductive filler having a specific surface area of from 5 to 500 m²/g. This has a wide range of the volume resistivity and does not solve the problems of the present invention.

### SUMMARY

Accordingly, one object of the present invention is to provide an electroconductive resin belt having good properties such as mechanical properties, electrical properties, flame resistance, surface glossiness (smoothness), image formability, resistivity controllability, forming stability and handleability.

Another object of the present invention is to provide a method of preparing the belt.

A further object of the present invention is to provide an image forming apparatus using the belt.

These objects and other objects of the present invention, either individually or collectively, have been satisfied by the discovery of an electroconductive resin belt, including a first resin selected from a first group consisting of polyetherimide-siloxane block copolymer, polyphenylene sulfide and polyimide; a second resin selected from a second group consisting of polyetherimide, polyether sulfone, polyester, aliphatic polyamide, polyetherimide-siloxane block copolymer and polyamideimide; carbon as a first conductant; and at least one second conductant selected from a third group consisting of particulate Al-doped ZnO, particulate Ga-doped ZnO, particulate Sb-doped SnO₂, particulate In-doped SnO₂, particulate P-doped SnO₂, and a fourth group consisting of metal oxides coated with any one of the members of the third group, wherein the first resin forms a continuous phase, the second resin forms a dispersion phase, the carbon is unevenly distributed in the dispersion phase or an arc therearound, the second conductant is present in both of the dispersion phase and the continuous phase, and the belt has a flame resistance of VTM-0 in UL94 standard when having a thickness of from 50 to 150 μm.

These and other objects, features and advantages of the present invention will become apparent upon consideration of the following description of the preferred embodiments of the present invention taken in conjunction with the accompanying drawings.

### BRIEF DESCRIPTION OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a schematic view illustrating a microphase structure of the electroconductive resin belt of the present invention;

FIG. 2A is a schematic view illustrating a circumference of a dispersion phase of the microphase structure, and FIG. 2B is an amplified schematic view illustrating a circumference of a dispersion phase of the microphase structure;

FIG. 3 is a diagram of showing a relation between the content of Si-O-PEI and glossiness with a compatibilizer compared with that without a compatibilizer.

FIG. 4 is a diagram of showing a relation between the content of carbon and that of Si-O-PEI in view of voltage dependency of the surface resistivity;

FIG. 5 is a schematic view illustrating a circular die formed of a die and a mandrel when forming an electroconductive resin belt by extrusion molding;

FIG. 6 is a diagram showing mechanical properties (relation between elasticity and MIT) when a first resin (Si-O-PEI) and a second resin (PBT) are mixed in embodiment 2;

FIG. 7 is a schematic view illustrating a microphase structure of the electroconductive resin belt including a fifth additive of the present invention;

FIG. 8 is a schematic view illustrating a microphase structure of the electroconductive resin belt including a fifth additive and a compatibilizer of the sixth group of the present invention;

FIG. 9 is a diagram showing mechanical properties (relation between elasticity and MIT) when a first resin (Si-O-PEI) and a second resin (PEI) are mixed in embodiment 3;

FIG. 10 is a schematic view for explaining process of preparing the electroconductive resin belt of the present invention; and

FIG. 11 is a diagram showing an example of a DSC curve of a semi-aromatic crystalline thermoplastic polyimide.

### DETAILED DESCRIPTION

The present invention provides a an electroconductive resin belt having good properties such as mechanical properties, electrical properties, flame resistance, surface glossiness (smoothness), image formability, resistivity controllability, forming stability and handleability. Further, the belt prevents production of abnormal images, defective cleaning and filming.

The electroconductive resin belt of the present invention specifically has the following properties.

1. Mechanical properties

(1) Flex resistance (MIT test): JIS-P8115, 2,000 times or more (Film thickness 90±10 [μm])

(2) Tensile elasticity: JIS-K7127 compliant, 1,500 [MPa] or more

2. Electrical properties

(1) Surface resistivity: 10⁸ to 10¹² [ohms per square], preferably 10⁸ to 10¹² [ohms per square] (under arbitrarily voltage from 100 to 500 [V])

(2) Volume resistivity: 10⁸ to 10¹² [ohm-cm] (under arbitrarily voltage from 100 to 250 [V])

(3) Voltage dependency (surface resistivity): within single digits (from 100 to 500 [V])

(4) Voltage dependency (volume resistivity): within double digits (from 100 to 250 [V])

(5) Environmental dependency (surface resistivity): within 0.5 digits (between 10 [°], 10 [%] RH and 30 [°], 90 [%] RH)

(6) Environmental dependency (volume resistivity): within single digits (between 10 [°], 10 [%] RH and 30 [°], 90 [%] RH)

3. Flame resistance: VTM-0 [μm], at the UL94 standard
4. Surface glossiness: 70 or more at 20 degrees mirror-glossiness (use PG-1, product of NIPPON DENSHOKU INDUSTRIES CO., LTD)
5. Abnormal images

No white spot, no scattered image, no void image, and no filming

6. Resistivity controllability

The reproducibility in the variation of the electric property upon the change of manufacturing condition is high.

The variation ratio [log-ohms per degree] of the volume resistivity according to the molding temperature is less than 0.2.

7. Molding stability:

Raw resin can be supplied stably and sustainably by the screw in the extruder.

The resin-melt pressure has a variation width not greater than 10% in the moldability-testing machine.

### 8. Handleability

Difficult to receive kink and scratch.

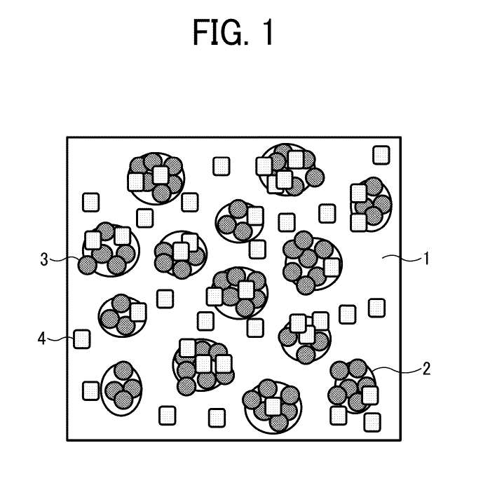

FIG. 1 is a schematic view illustrating a microphase structure of the electroconductive resin belt of the present invention.

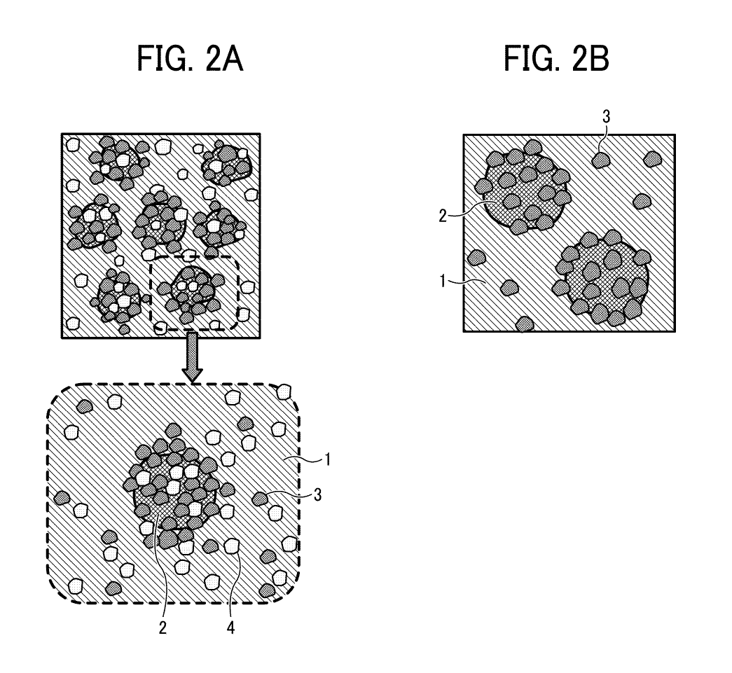

In FIG. 1, a dispersion phase 2 of Si-O-PEI is dispersed in a continuous phase 1 of PPS, carbon 3 as a first conductant is unevenly distributed in the dispersion phase 2, and a second conductant 4 is distributed in the continuous phase 1 and the dispersion phase 2. That the carbon is unevenly distributed in the dispersion phase or an arc therearound is defined as that carbon 3 is unevenly distributed in the dispersion phase or an arc therearound in an amount not less than 80% relative to the total number of carbon 3 in an area of 3 μm×3 μm in each of the dispersion phases 2 (FIGS. 2A and 2B).

Thus, the electroconductive resin belt of the present invention has a flame resistance of VTM-0 under a condition that a thickness thereof is from 50 to 150 μm at a UL94 standard.

Further, in an embodiment of the present invention, the electroconductive resin belt includes at least one additive selected from the following fifth group, and the additive forms another dispersion phase.

(Fifth Group) Silicone oil, metal soap, particulate polyimide and particulate silicone

The additive reduces screw load factor, stabilizes kneading and extrusion molding. A suitable amount thereof prevents glossiness from lowering and achieves targeted glossiness. In addition, bleed out is prevented to obtain an electroconductive belt having good durability. Further, in an embodiment of the present invention, the electroconductive resin belt may include an additive selected from the following sixth group.

(Sixth Group) Ethylene-glycidylmethacrylate copolymer and polymer including an oxazoline group

The additive of the sixth group works as a compatibilizer capable of downsizing the dispersion phase. The small dispersion phase size improves glossiness and surface roughness. The content of each of SI-O-PEI and the second resin needs to be 5% by weight without a compatibilizer, but the content of the second resin may be 10% by weight.

The present invention provides a polymer blending formulation and a method of preparing kneaded mixture, unevenly distributing carbon in the dispersion phase (island) or an arch therearound, and presenting the second conductant in both of the continuous phase and the dispersion phase.

One of the methods of preparing the belt of the present invention is as follows.

### (Production Method 1)

The method includes a process of pulverizing the first and the second resins to form particles having an average particle diameter not greater than 300 μm, a process of stirring the particles, carbon as a first conductant and at least one second conductant selected from the third and fourth groups at a high speed of from 1,000 to 3,000 rpm, a process of melting and kneading the mixture at 260 to 330° C. to prepare a melted and kneaded mixture, and a process of molding the melted and kneaded mixture by extrusion.

The polymer materials are pulverized and dispersed at high speed before kneaded to improve dispersibility of the conductant and the belt has uniform electrical properties.

### (Production Method 2)

The method includes (1) a process of pulverizing the first and the second resins separately to form particles having an average particle diameter not greater than 300 μm, respectively, (2) a process of stirring the second resin particles and carbon as a first conductant at a high speed of from 1,000 to 3,000 rpm and melting and kneading the mixture at 260 to 330° C. to prepare a melted and kneaded mixture, (3) a process of stirring the first resin particles and at least one second conductant selected from the third and fourth groups at a high speed of from 1,000 to 3,000 rpm, (4) a process of melting and kneading the melted and kneaded mixture prepared in the process (2) and the mixture prepared in the process (3) at 290 to 330° C. to prepare a melted and kneaded mixture, and (5) a process of molding the melted and kneaded mixture by extrusion.

The two-stage melting and kneading process improves dispersibility of the dispersion phase 2 to improve electrical properties and reduce aggregation of carbon.

### <Explanation on Phase Separation Structure and Carbon Dispersion>

The alloyed first and second resins are incompatible with each other to form a phase separation structure. Typically, the phase separation structure includes a continuous phase (sea) formed by the resin larger in number and a dispersion phase (island) formed by the resin smaller in number. In order to maintain mechanical properties of the first resin, the first and the second resin are blended such that the first resin forms a continuous phase (sea) and the second resin forms a dispersion phase (island). The carbon is unevenly distributed in the second resin of the dispersion phase and is not present in the first resin of the continuous phase when the cross-section of a film is observed by TEM. (The uneven distribution of carbon in a polymer alloy is well known. There are some theories of the uneven distribution, but are not fully verified, and still depends on experiments. As a matter of course, the uneven distribution of carbon in an alloyed resin has not been reported at all.

Typically, the carbon has orientation and tends to be largely influenced by the molding conditions. When the carbon is present in the continuous phase, electrical properties, particularly voltage dependency tends to be large. However, the carbon in the dispersion phase is less influenced by the molding conditions, and the electrical properties are more easily controlled.

### <Explanation of First Conductant>

Typically, an electroconductive carbon which is relatively inexpensive and less dependent on environment is preferably used. Carbon includes furnace black, channel black, acetylene black, Ketjenblack, etc., according to its production methods. Since PPS of the present invention has a high molding temperature of 300° C., carbon having less volatile component is preferably used not to foam at high temperature. Carbon including a volatile component in an amount not greater than 2.0% when heated at 950° C. for 7 min is preferably used. The more the carbon, the lower the resistivity. The content of carbon to have a targeted resistivity depends on the kind of carbon, particularly on DBP (dibutylphthalate) amount (JISK6221).

The less the carbon, the more advantageous for mechanical properties and glossiness. The more the carbon, the lower the mechanical properties, the glossiness and the surface smoothness (mainly causing filming). Particularly, flex resistance largely lowers. Ketjenblack having a large DBP value is preferably used to have a targeted resistivity, but is not used often due to voltage dependency and poor reproducibility.

The voltage dependency is caused by different conductive paths due to voltage and influenced by carbon dispersion uniformity. Since more particles are preferably dispersed to decrease a difference of distance of the conductive paths in order to improve dispersion uniformity, furnace black or acetylene black having relatively a small DBP amount is used.

In the present invention, the carbon is closed in the dispersion phase (island) and difficult to transfer to improve voltage dependency and reproducibility. Therefore, Ketjenblack advantageously used for mechanical properties, glossiness and filming can be used. Further, a combination of Ketjenblack and large-size carbon improves surface forming stability and positional uneven volume resistivity.

### <Explanation of Second Conductant>

The carbon as the first conductant is an orienting material. Depending on extrusion conditions, the carbon is differently dispersed at different positions of the belt. Therefore, it is difficult to control the belt to have desired surface resistivity and volume resistivity. PPS is a crystalline material and a crystallized parts orients. Together with PPS orientation, the carbon orients as well. Therefore, it is difficult to control resistivity in a thickness direction, and the volume resistivity tends to be higher than the surface resistivity. Therefore, a second conductant which is not influenced by a polymer orientation and not unevenly distributed as carbon is studied in consideration of the above properties 1 to 8.

As a result, the second conductant is preferably at least one material selected from the following third and fourth groups.

(Third Group) Particulate Al-doped ZnO, particulate Ga-doped ZnO, particulate Sb-doped SnO₂, particulate In-doped SnO₂ and particulate P-doped SnO₂

(Fourth Group) Metal oxides coated with any one of the members of the third group

The second conductant preferably has an average primary particle diameter not greater than 100 nm, and more preferably from 10 to 50 nm. When larger than 100 nm, there are no problem of electrical properties, but surface smoothness deteriorates and filming tends to occur.

Hereinafter, embodiments of the present invention are explained referring to specific examples of combinations of the first and the second resins.

Polyphenylene sulfide resin is referred to as PPS, and polyetherimide-siloxane block copolymer resin is referred to as Si-O-PEI.

### Embodiment 1

In this embodiment, PPS is used as the first resin and Si-O-PEI is used as the second resin.

Mechanical properties and flame resistance of the electroconductive resin belt are largely influenced by polymer materials. Materials having good mechanical properties and flame resistance include polyphenylene sulfide resin (PPS); polyether ether ketone (PEEK) which is an engineering plastic crystalline polymer having flame resistance itself; and fluorine materials such as polyvinylidenedifluoride (PVDF) and ethylene-tetrafluoroethylene copolymer (ETFE).

This embodiment enables the belt to have flexibility and Si-O-PEI having flame resistance itself is used together.

PEEK having a high molding temperature of from 370 to 390° C. cannot be alloyed. Namely, Si-O-PEI cannot be used because it deteriorates with heat at the molding temperature of PEEK and forms particles. Fluorine materials such as PVDF and ETFE cannot achieve the above 1-(2) tensile elasticity and 4 surface glossiness. Amorphous materials such as PEI, PES and PSF cannot enlarge flex resistance.

A PPS belt has problems caused by its polymer of the above 4 surface glossiness and 8 handleability. An electroconductive PPS belt initially has good glossiness of from 70 to 120°. When installed in a copier as an intermediate transfer belt, a toner and a paper powder adhere to images as they are produced, and the images are clouded, resulting in low glossiness. The low glossiness increases a current value of a photosensor determining whether toner remains, resulting in shorter life of the photosensor and its incapability of determining whether toner remains.

The embodiment is made in consideration of the above, and Si-O-PEI is alloyed to PPS and further blended with silicone oil and a metal soap when necessary to solve the problems 1 to 8. As a result, an electroconductive resin belt preventing itself from breaking when running; solving problems of abnormal images such as filming (glossiness changes as images are produced), white spots, scattered images and void images; being easy to control properties and have reproducibility; being producible at low cost; and having flame resistance to comply with high-level safety demands. Typically, in a polymer alloy, a resin blended in a larger amount becomes a continuous phase and a resin blended in a smaller amount becomes a dispersion phase. In this embodiment, polymer blend formulation is studied such that carbon is unevenly distributed in a dispersion phase, and a conductant which is not carbon and carbon are unevenly distributed only in a continuous phase. The uneven distribution means that a conductivity imparting agent has an existence probability is not less than 95%.

### Embodiment 1-1

First, embodiment 1-1 is explained.

This embodiment is an electroconductive resin belt including a polyphenylene sulfide resin (PPS), a polyetherimide-siloxane block copolymer (Si-O-PEI), carbon as the first conductant, and at least one second conductant selected from the following third group and the fourth group. PPS forms a continuous phase, Si-O-PEI forms a dispersion phase, the carbon is unevenly distributed in the dispersion phase, and the second conductant is present in both of the dispersion phase and the continuous phase. The belt has a flame resistance of VTM-0 in UL94 standard when having a thickness of from 50 to 150 μm.

(Third Group) Particulate Al-doped ZnO, particulate Ga-doped ZnO, particulate Sb-doped SnO₂, particulate In-doped SnO₂, particulate P-doped SnO₂,

(Fourth Group) Metal oxides coated with any one of the members of the third group

### <Explanation of Polymer Formulation>

Polyphenylene sulfide (PPS) is a flame-resistant polymer having a composition as shown in the following formula (1). According to a broadly-classification, there are a crosslinking-pattern polymer and a linear polymer. Herein, the linear polymer is appropriate for manufacturing a thin-film belt member as the intermediate-transfer belt 61. It is appropriate to avoid using the cross-linking polymer or to use such a polymer at minimum because it includes much gelling agent which shows up as a foreign-object defect on the surface after the film is formed.

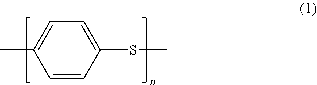

The liner polymer includes products having different molecular weights. The different molecular weights differentiate melt viscosities and MFI values. A large molecular weight increases viscosity (lowers MFI value).

A polymeric PPS gas good mechanical properties, and particularly has good flex resistance. It has a high flex resistance (0.38 R) of from 10,000 to 30,000 times at MFI value (ASTMD 1238, 300° C.) of from 20 to 30 g/10 min, a flex resistance (0.38 R) of from 2,000 to 5,000 times at MFI value of from 60 to 80 g/10 min, and a flex resistance (0.38 R) of from 1,000 to 3,000 times at MFI value of from 90 to 120 g/min. However, the smaller the MFI value, the more polymeric PPS, and therefore unmelted PPS is likely to generate, resulting in appearance of undesired particles on the surface of a film. Then, a method of improving mechanical properties even when using low-molecular-weight PPS was studied.

Typically, combinations of alloyed thermoplastic resins to improve mechanical properties are known. As alloying agents of PPS, thermoplastic resins which do not deteriorate at PPS molding temperature and maintain flame resistance even when alloyed include polyether imide, polyether sulfone polysulfone and polyether ether ketone. For example, when a small amount (3 to 20% by weight) of polyether imide is blended and alloyed, the flex resistance (0.38 R) is improved by 1.5 to 2.5 times, and therefore even a low-molecular-weight PPS improves mechanical properties with polyether imide. Since polyether imide is a flame resistant material, it has no problem of flame resistance when alloyed, but the above 8 handleability is not improved. PPS is very likely to generate kink when being a thin film (60 to 100 μm). Kink is prevented when thick (100 to 200 μm), but flex resistance (0.38 R) largely lowers and durability lowers. As a result of keen studies of the present inventors on a formulation for hardly causing less kink and achieving a flex resistance (0.38 R) not less than 2,000 times with a thin film (60 to 100 μm) of a low-molecular-weight PPS, PPS alloyed with Si-O-PEI of the present invention is completed. PPS and Si-O-PEI are alloyed to maintain flame resistance (VTM-0), prevent kink even on a thin film (60 to 100 μm) and achieve a flex resistance (0.38 R) not less than 2,000 times.

Having flexible siloxane, Si-O-PEI is blended with PPS to largely improve kink occurrence of PPS and increase flex resistance more than that of PPS alone before alloyed.

Siloxane improves flame resistance as well. Typically, the thinner, the more flammable, but VTM-0 can be achieved even at 50 μm in the present invention.

The electroconductive resin belt of this embodiment exerts the following effects.

(1) PPS alloyed with Si-O-PEI improves flex resistance.
(2) PPS alloyed with Si-O-PEI having high flexibility improves handleability and prevents surface concavo and convex defects such as kinks and dents.
(3) Carbon conductant is unevenly distributed in a dispersion phase, a second conductant is present in both of a continuous phase and the dispersion phase, and the contents of the conductants are controlled to independently control the surface resistivity and the volume resistivity, and improve voltage dependency and targeted electrical properties can be achieved.
(4) A metal oxide having low hygroscopicity is used to provide an electroconductive belt satisfying environmental dependency of the resistivity.
(5) Carbon is unevenly distributed in a dispersion phase and closed therein to prepare an electroconductive resin belt having stable resistivity, influenced less by molding temperature and modification speed.
(6) Ketjenblack realizing resistivity in a small amount can be used because of being unevenly distributed in a dispersion phase and closed therein. Conductants are used less to prevent mechanical properties from lowering and improve flex resistance.
(7) All the constitutional materials have high flame resistance to provide an electroconductive resin belt having VTM-0 in UL94 standard.
(8) Low-cost carbon as well as metal oxide are used to provide an inexpensive electroconductive belt.

### Embodiment 1-2

Embodiment 1-2 is explained.

This embodiment is an electroconductive resin belt including PPS, Si-O-PEI, carbon as the first conductant, at least one second conductant selected from the following third group and the fourth group, and at least one additive selected from the following fifth group. PPS forms a continuous phase, Si-O-PEI forms a dispersion phase, the carbon is unevenly distributed in the dispersion phase, and the second conductant is present in both of the dispersion phase and the continuous phase. The belt has a flame resistance of VTM-0 in UL94 standard when having a thickness of from 50 to 150 μm.

(Third Group) Particulate Al-doped ZnO, particulate Ga-doped ZnO, particulate Sb-doped SnO₂, particulate In-doped SnO₂, particulate P-doped SnO₂,

(Fourth Group) Metal oxides coated with any one of the members of the third group

(Fifth Group) Silicone oil and metal soap

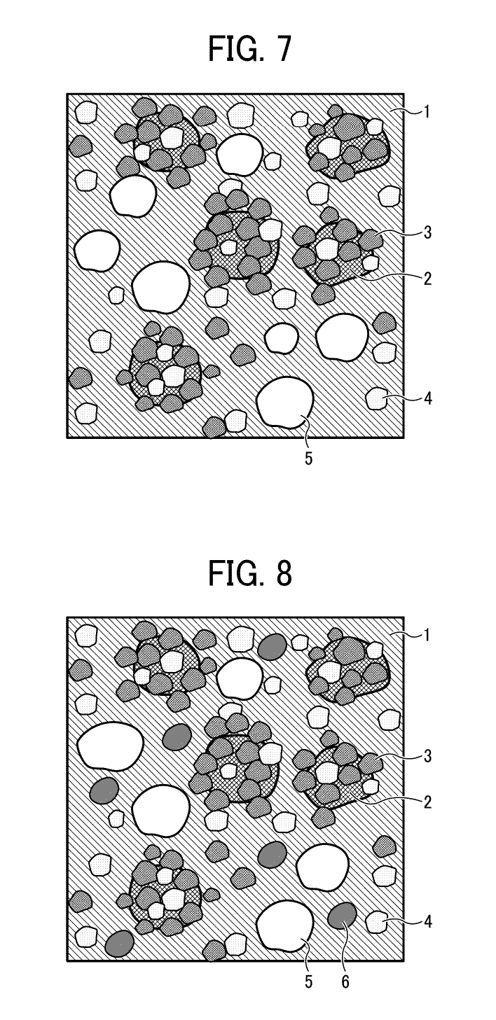

The electroconductive resin belt in this embodiment has the micro-phase structure in FIG. 7.

In order to improve the above 7 molding stability, a screw load of the molder is effectively reduced. Silicone oils such as dimethyl silicone, methyl phenyl silicone, methyl hydrogen silicone and circular dimethyl silicone are effectively used to reduce the screw load. Particularly, methyl phenyl silicone and methyl hydrogen silicone are preferably used.

In addition, silicone oil is preferably used to improve the above 5 abnormal images: filming.

A metal soap exerts the same effect as that of silicone oil.

Specific examples of the metal soap include, but are not limited to, metal salt stearate, metal salt 12 hydroxy stearate, metal salt montanate, metal salt behenate and metal salt laurate. Metal soaps which do not deteriorate with heat, i.e., a molding temperature of from 300 to 340° C. of PPS are preferably used. For example, lithium stearate, calcium montanate, lithium montanate, and sodium 12 hydroxy stearate, etc. are preferably used.

In addition to the above effects (1) to (8) of the electroconductive belt of embodiment 1-1, the electroconductive resin belt of embodiment 1-2 exerts the following effects.

(1) Silicone oil and metal soap are blended to reduce filming on the surface of the belt, and a belt having high durability can be provided.

(2) Silicone oil and metal soap are blended to stabilize extrusion moldability and decrease resin pressure variation.

### Embodiment 1-3

Embodiment 1-3 is explained.

This embodiment is the electroconductive resin belt of the embodiments 1-1 or 1-2 except that Si-O-PEI is blended to PPS in an amount not greater than 10% by weight and carbon as the first conductant is blended less than Si-O-PEI.

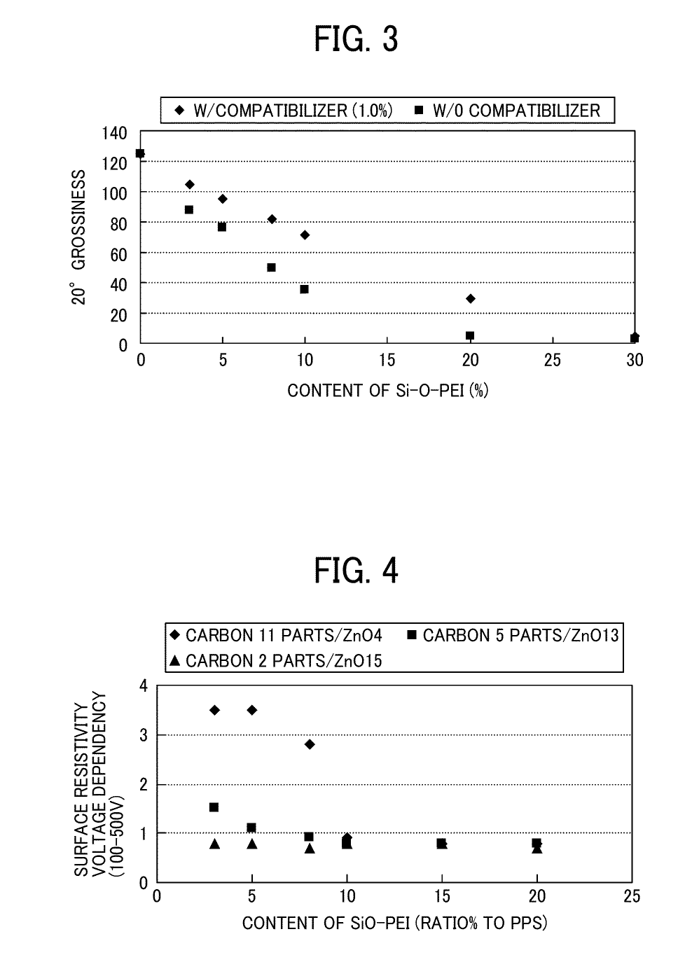

Since PPS and Si-O-PEI are incompatible with each other, Si-O-PEI forms a micro-phase separation structure as a dispersion phase. The larger the dispersion phase, the lower the surface glossiness. As FIG. 3 shows, when PPS+Si-O-PEI is 100, Si-O-PEI is blended in an amount greater than 10% by weight, the targeted glossiness is less than 70°, Si-O-PEI is preferably blended in an amount not greater than 10% by weight. Carbon is unevenly distributed to Si-O-PEI in the dispersion phase. As for the relation between an amount of carbon and Si-O-PEI, an evaluation in view of voltage dependency of the surface resistivity is shown in FIG. 4. The voltage dependency tends to lower when an amount of Si-O-PEI is large. Further, Si-O-PEI is less than carbon, the voltage dependency of the surface resistivity between 100 to 500V is not greater than 1 digit.

In addition to the effects of the electroconductive belt of embodiments 1-1 and 1-2, the electroconductive resin belt of embodiment 1-3 exerts the following effects.

(1) Si-O-PEI is blended in an amount not greater than 10% by weight to prevent the glossiness from lowering and achieve targeted glossiness.

(2) Carbon is blended less than Si-O-PEI to decrease carbon density in the dispersion phase, improve surface smoothness, and stabilize electrical properties.

### Embodiment 1-4

Embodiment 1-4 is explained.

This embodiment is the electroconductive resin belt of any one of the embodiments 1-1 to 1-3 except that the first and the second conductants have an average primary particle diameter not greater than 100 nm.

Electroconductive carbon has a particle diameter of from 10 to 80 nm. When the carbon is dispersed without aggregation, the surface roughness does not worsen. The second conductants have different particle diameters, and a large particle diameter worsens the surface roughness, resulting in filming, i.e., a toner or a paper powder anchor.

When greater than 100 the surface roughness is not greater than 0.4 μm.

In this embodiment, the first and the second conductants have an average primary particle diameter not greater than 100 nm.

The electroconductive resin belt of embodiment 1-4 exerts the following effect in addition to the effects of the electroconductive belt of any one of the embodiments 1-1 to 1-3.

The first and the second conductants have an average primary particle diameter not greater than 100 nm to improve surface smoothness and glossiness, and decrease filming.

### Embodiment 1-5

Embodiment 1-5 is explained.

This embodiment is the electroconductive resin belt of any one of the embodiments 1-1 to 1-4 except that the additive of the fifth group is blended in an amount of from 0.1 to 2.0% by weight, and preferably from 0.2 to 1.0% by weight.

When the additive of the fifth group is blended much, mechanical strength decreases, bleed out occurs, glossiness and images tend to deteriorate.

The additive of the fifth group is preferably blended in an amount of from 0.1 to 2.0% by weight, and more preferably from 0.2 to 1.0% by weight.

The electroconductive resin belt of embodiment 1-5 exerts the following effect in addition to the effects of the electroconductive belt of any one of the embodiments 1-1 to 1-4.

The additive of the fifth group such as silicone oil and metal soap is blended in an amount of from 0.1 to 2.0% by weight, and preferably from 0.2 to 1.0% by weight to decrease screw load, and therefore kneading and extrusion molding can stably be made. A suitable amount thereof prevents the glossiness from lowering to achieve targeted glossiness. Bleed out is prevented, and an electroconductive belt having high durability is provided.

### Embodiment 1-6

Embodiment 1-6 is explained.

This embodiment is the electroconductive resin belt of any one of the embodiments 1-1 to 1-5 except that at least one compatibilizer selected from the following sixth group is blended in an amount of from 0.1 to 2.0% by weight, and preferably from 0.2 to 1.0% by weight based on total weight of PPS and Si-O-PEI.

(Sixth Group) Ethylene-glycidyl methacrylate copolymer and polymer including an oxazoline group.

The electroconductive resin belt in this embodiment has the micro-phase structure in FIG. 8. In FIG. 8, a compatibilizer 6 is further dispersed in that of FIG. 7.

The materials in the sixth group work as compatibilizers and can downsize the dispersion phase. The dispersion phase having a small size improves glossiness and surface roughness. As FIG. 3 shows, in order to make glossiness not less than 70°, Si-O-PEI needs to be blended in an amount not greater than 5% by weight without a compatibilizer, but can be blended in an amount to 10% by weight with a compatibilizer.

When a compatibilizer is blended too much, mechanical strength lowers, bleed out occurs, and glossiness and images tend to deteriorate. The materials in the sixth group is preferably blended in an amount of from 0.1 to 2.0% by weight, and more preferably from 0.2 to 1.0% by weight.

The electroconductive resin belt of embodiment 1-6 exerts the following effect in addition to the effects of the electroconductive belt of any one of the embodiments 1-1 to 1-5.

At least one compatibilizer selected from the following sixth group is blended in an amount of from 0.1 to 2.0% by weight, and preferably from 0.2 to 1.0% by weight based on total weight of PPS and Si-O-PEI to downsize the dispersion phase and form a uniform micro-phase separation structure.

### Embodiment 1-7

Embodiment 1-7 is explained.

This embodiment is the electroconductive resin belt of any one of the embodiments 1-1 to 1-6 except for having a volume resistivity at 100 V (Rv100 [Ω·cm]) of from 10⁸ to 10¹² [Ω·cm] and a surface resistivity of from at 500 V (Rv500 [Ω·cm]) of from 10⁸ to 10¹² [Ω/□].

The electroconductive resin belt of embodiment 1-7 exerts the following effect in addition to the effects of the electroconductive belt of any one of the embodiments 1-1 to 1-6.

The electroconductive resin belt having the above electrical properties realizes an image forming apparatus producing high-quality images.

### Embodiment 1-8

Embodiment 1-8 is explained.

This embodiment is a method of preparing the electroconductive resin belt of any one of the embodiments 1-1 to 1-7.

The method includes a process of pulverizing PPS and Si-O-PEI to form particles having an average particle diameter not greater than 300 μm, a process of stirring the particles, carbon as a first conductant and at least one second conductant selected from the following third and fourth groups at a high speed of from 1,000 to 3,000 rpm, a process of melting and kneading the mixture at 290 to 330° C. to prepare a melted and kneaded mixture, and a process of molding the melted and kneaded mixture by extrusion.

(Third Group) Particulate Al-doped ZnO, particulate Ga-doped ZnO, particulate Sb-doped SnO₂, particulate In-doped SnO₂ and particulate P-doped SnO₂

(Fourth Group) Metal oxides coated with any one of the members of the third group

The method of embodiment 1-8 exerts the following effect.

Polymer materials are pulverized and dispersed at high speed before kneaded to improve dispersibility of the conductants and achieve uniform electrical properties.

### Embodiment 1-9

Embodiment 1-9 is explained.

This embodiment is a method of preparing the electroconductive resin belt in addition to the method of the embodiment 1-8.

In the process of stirring the particle at a high speed of from 1,000 to 3,000 rpm, together with the first and the second conductants, at least one additive selected from the following fifth group or at least one additive selected from the following fifth group and at least one compatibilizer selected from the sixth group.

(Fifth Group) Silicone oil, metal soap, particulate polyimide and particulate silicone

(Sixth Group) Ethylene-glycidylmethacrylate copolymer and polymer including an oxazoline group

The method of embodiment 1-9 exerts the following effects.

An additive such as silicone oil and a metal soap of the fifth group decreases screw load to stabilize kneading and extrusion molding.

At least one compatibilizer selected from the sixth group downsizes the dispersion phase to form a uniform micro-phase separation structure.

### Embodiment 1-10

Embodiment 1-10 is explained.

In the molding process in the method of preparing the electroconductive resin belt of the embodiment 18 or 19, a cylindrical member called mandrel is located under a die, which cools the melted and kneaded material to have a temperature not higher than its glass transition temperature.

### <Melting and Kneading Process>

Melting and kneading process is not particularly limited, and can be performed using, e.g., kneaders such as a monoaxial extruder, a biaxial extruder, a Bumbury's Mixer, a roll and a kneader.

### <Extrusion Molding Process>

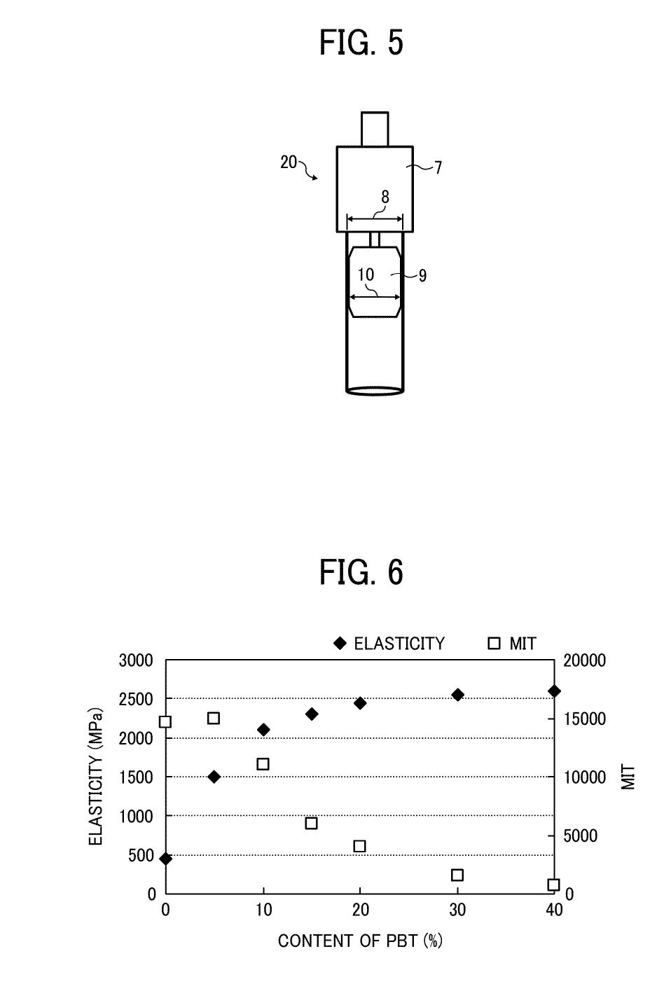

FIG. 5 is a schematic view illustrating a circular die formed of a die and a mandrel when forming an electroconductive resin belt by extrusion molding. A circular die 20 formed of a spiral die 7 and a mandrel 9 directly connected to the bottom thereof. The mandrel 9 is connected with an oil temperature adjustor and the temperature thereof can be controlled. The mandrel has, e.g., a temperature not higher than a glass transition temperature of a polymer alloy, which is solidified while passing the mandrel 9 to have the same size (circumferential length) as a mandrel diameter 10. The mandrel 9 has many production advantages such as stable control of the size (circumferential length), less influence of outer air, less influence of oscillation and easier arrangements before preparation. Considering properties of intermediate transfer belt, particularly reduction of anisotropy of electrical properties first, a die slip diameter 8 and the mandrel diameter 10 are preferably same. The mandrel diameter 10 can be controlled by about 10% less than the die slip diameter 8 without additional modification of a molder. It may be controlled by about 50% less than the die slip diameter 8 to reduce thickness deviation of intermediate transfer belt.

The method of embodiment 1-10 exerts the following effects.

The size and thickness deviation are easily controlled, and production reproducibility is high.

### Embodiment 1-11

Embodiment 1-11 is explained.

This embodiment is an image forming apparatus including at least an electrostatic latent image former to form an electrostatic latent image on an image bearer, an image developer developing the electrostatic latent image on an image bearer formed on the image bearer with a toner to form a toner image, a first transferer to transfer the toner image on the image bearer onto an intermediate transfer belt, a second transferer to transfer the toner image on the intermediate transfer belt onto a recording medium and a fixer to fixing the toner image on the recording medium. The intermediate transfer belt is the electroconductive resin belt of any one of the embodiments 1-1 to 1-7.

### Embodiment 1-12

Embodiment 1-12 is explained.

This embodiment is an image forming apparatus including at least an electrostatic latent image former to form an electrostatic latent image on an image bearer, an image developer developing the electrostatic latent image on an image bearer formed on the image bearer with a toner to form a toner image, a transfer belt to transfer the toner image on the image bearer onto a recording medium and a fixer to fixing the toner image on the recording medium. The transfer belt is the electroconductive resin belt of any one of the embodiments 1-1 to 1-7.

### Embodiment 2

In this embodiment, Si-O-PEI is used as the first resin and polyester or aliphatic polyamide is used as the second resin.

Si-O-PEI including a siloxane bond in its molecule has high lubricity, which prevents abnormal images due to adherence of a toner and a paper powder to the surface of the belt while images are produced.

Siloxane block imparts flexibility, and improves MIT value and flame resistance. However, the above 1-(2) tensile elasticity largely lowers. The belt becomes so soft as to have low durability because glossiness changes and the surface is scratched while images are produced. The tensile strength is low and the thickness needs to be thicker, resulting in cost-up.

The embodiment is made in consideration of the above, and polyester or aliphatic polyamide as the second resin is alloyed to Si-O-PEI and further blended with silicone oil and a metal soap when necessary to solve the above problem. As a result, an electroconductive resin belt preventing itself from breaking when running; solving problems of abnormal images such as filming (glossiness changes as images are produced), white spots, scattered images and void images; being easy to control properties and have reproducibility; being producible at low cost; and having flame resistance to comply with high-level safety demands. Typically, in a polymer alloy, a resin blended in a larger amount becomes a continuous phase and a resin blended in a smaller amount becomes a dispersion phase. In this embodiment, polymer blend formulation is studied such that carbon is unevenly distributed in a dispersion phase, and a conductant which is not carbon and carbon are unevenly distributed only in a continuous phase.

### Embodiment 2-1

Embodiment 2-1 is explained.

This embodiment is an electroconductive resin belt including Si-O-PEI, polyester or aliphatic polyamide as the second resin in an amount of from 1 to 10% by weight based on total weight of the polymer, carbon as the first conductant, and at least one second conductant selected from the following third group and the fourth group. The belt has a flame resistance of VTM-0 in UL94 standard when having a thickness of from 50 to 150 μm. Si-O-PEI forms a continuous phase, the second resin forms a dispersion phase, the carbon is unevenly distributed in the dispersion phase, and the second conductant is present in both of the dispersion phase and the continuous phase.

As shown in FIG. 1, the dispersion phase 2 of polyester or aliphatic polyamide is dispersed in the continuous phase 1 of the first resin Si-O-PEI. The first conductant carbon black 3 is unevenly dispersed in the dispersion phase 2, and the second conductant 4 is distributed in the continuous phase 1 and the dispersion phase 2.

### <Explanation of Polymer Formulation>

### <<Polyetherimide-Siloxane Block Copolymer Resin (Si-O-PEI)>>

Si-O-PEI is a soft material including polyetherimide and flexible siloxane. Si-O-PEI has good flex resistance (MIT test). A belt formed of a material having an MFI value (ASTMD1238, 295° C.) of 12 g/10 min including carbon by 10% has very high flex resistance (0.38 R) of from 5,000 to 20,000 times. However, the elasticity is 450 Mpa which is lower than targeted 1,000 Mpa.

In order to improve the elasticity, PEI or PES having high elasticity is alloyed. Polyester and nylon have good dispersibility with carbon. When alloyed with Si-O-PEI, carbon is unevenly distributed in polyester or nylon which is a dispersion phase, and the belt has good electrical properties.

Siloxane group improves flame resistance. Typically, the thinner, the more flammable. In the present invention, VTM-0 is achieved even at 50 μm.

### <<Polyester>>

Polyester in the present invention is aliphatic polyester such as crystalline polymers such as PET having the following formula (2) and PBT having the following formula (3).

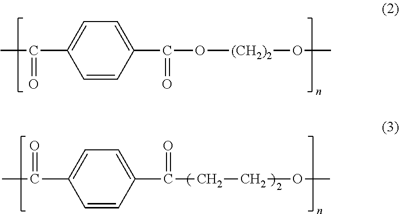

Other materials such as polymethyleneterephthalate (PTT), polyethylenenaphthalate (PEN) and polybutylenenaphthalate (PBN) may be used as well.

However, polyester used in the present invention exclude aromatic polyester.

Mechanical properties (relativity between elasticity and MIT) when PBT is blended with Si-O-PEI are shown in FIG. 6. PBT improves elasticity, but tends to lower MIT value.

When the elasticity has a standard value not less than 1,000 MPa and a MIT value not less than 5,000 times, PBT is included in an amount of from 3 to 10% in consideration of lowering flame resistance. PBT has the most suitable (reference) range of amount although varied according to viscosity (MFI value) and molding conditions such as temperature, extrusion speed, and receiving speed and temperature.

### <Aliphatic Polyamide>

The aliphatic polyamide is, e.g., a crystalline polymer having the formula (3). The polyamides differ according to the kinds thereof, but typically have good abrasion resistance and self-lubricity. Specific examples of the aliphatic polyamide include 4, 6-nylon, 6-nylon, 6-6-nylon, 12-nylon etc. It has good dispersibility with the first conductant carbon.

The second group polymer having low flame resistance is blended in an amount 1 to 10% by weight base on total weight of inflammable Si-O-PEI to maintain flame resistance and achieve a tensile elasticity not less than 1,000 Mpa.

A large dispersion phase lowers the surface glossiness. As mentioned above, carbon is unevenly distributed in polyester or aliphatic amide. When an amount thereof is increased, voltage dependency tends to lower.

It is preferable that polyester or aliphatic amide and carbon are melted and kneaded to prepare melted and kneaded materials first, and next, the melted and kneaded materials, Si-O-PEI and the second conductant are melted and kneaded. The two-stage melting and kneading process improves dispersibility of the dispersion phase 2 to improve electrical properties and reduce aggregation of carbon.

The electroconductive resin belt of this embodiment exerts the following effects.

(1) The second group polymer is alloyed with Si-O-PEI to improve flex resistance and tensile elasticity.

(2) The second group polymer is blended in an amount of from 1 to 10% by weight to prevent the glossiness from lowering and achieve targeted glossiness.

(3) The second group polymer is blended in an amount of from 1 to 10% by weight to expect improvement of flex resistance.

(4) Carbon conductant is unevenly distributed in a dispersion phase, a second conductant is present in both of a continuous phase and the dispersion phase, and the contents of the conductants are controlled to independently control the surface resistivity and the volume resistivity, and improve voltage dependency and targeted electrical properties can be achieved.

(5) A metal oxide having low hygroscopicity is used to provide an electroconductive belt satisfying environmental dependency of the resistivity.

(6) Carbon is unevenly distributed in a dispersion phase and closed therein to prepare an electroconductive resin belt having stable resistivity, influenced less by molding temperature and modification speed.

(7) Ketjenblack realizing resistivity in a small amount can be used because of being unevenly distributed in a dispersion phase and closed therein. Conductants are used less to prevent mechanical properties from lowering and improve flex resistance.

(8) All the constitutional materials have high flame resistance to provide an electroconductive resin belt having VTM-0 in UL94 standard.

(9) Low-cost carbon as well as metal oxide are used to provide an inexpensive electroconductive belt.

(10) Si-O-PEI improves surface smoothness, cleanability and prevention of filming.

### Embodiment 2-2

This embodiment is an electroconductive resin belt including Si-O-PEI, the following second group polymer in an amount of from 1 to 10% by weight based on total weight of the polymer, carbon as the first conductant, at least one second conductant selected from the following third group and the fourth group, and at least one additive selected from the following fifth group. Si-O-PEI faults a continuous phase, each the second group polymer and the fifth group additive forms a dispersion phase, the carbon is unevenly distributed in the dispersion phase of the second group polymer, the second conductant is present in both of the dispersion phase and the continuous phase. The belt has a flame resistance of VTM-0 in UL94 standard when having a thickness of from 50 to 150 μm.

(Second Group) Polyester and aliphatic polyamide

(Third Group) Particulate Al-doped ZnO, particulate Ga-doped ZnO, particulate Sb-doped SnO₂, particulate In-doped SnO₂, particulate P-doped SnO₂,

(Fourth Group) Metal oxides coated with any one of the members of the third group

(Fifth Group) Silicone oil and metal soap

The electroconductive resin belt in this embodiment 2-2 has the micro-phase structure in FIG. 7.

In FIG. 7, a dispersion phase 2 of the second group polymer and a dispersion phase 5 of the fifth group additive are dispersed in the continuous phase 1 of Si-O-PEI. The first conductant carbon black 3 is unevenly distributed in the dispersion phase 2, and the second conductant is distributed in both of the continuous phase 1 and the dispersion phase 2.

In order to improve the above 7 molding stability, a screw load of the molder is effectively reduced. Silicone oils such as dimethyl silicone, methyl phenyl silicone, methyl hydrogen silicone and circular dimethyl silicone are effectively used to reduce the screw load. Particularly, methyl phenyl silicone and methyl hydrogen silicone are preferably used.

In addition, silicone oil is preferably used to improve the above 5 abnormal images: filming.

A metal soap exerts the same effect as that of silicone oil.

Specific examples of the metal soap include, but are not limited to, metal salt stearate, metal salt 12 hydroxy stearate, metal salt montanate, metal salt behenate and metal salt laurate. Metal soaps which do not deteriorate with heat, i.e., a molding temperature of from 260 to 340° C. of Si-O-PEI and the second group polymer are preferably used. For example, lithium stearate, calcium montanate, lithium montanate, and sodium 12 hydroxy stearate, etc. are preferably used.

In addition to the above effects (1) to (10) of the electroconductive belt of embodiment 2-1, the electroconductive resin belt of embodiment 2-2 exerts the following effects.

(11) Silicone oil and metal soap are blended to reduce filming on the surface of the belt, and a belt having high durability can be provided.

(12) Silicone oil and metal soap are blended to stabilize extrusion moldability and decrease resin pressure variation.

### Embodiment 2-3

Embodiment 2-3 is explained.

This embodiment is the electroconductive resin belt of the embodiment 2-1 or 2-2 except that the first and the second conductants have an average primary particle diameter not greater than 100 nm.

Electroconductive carbon has a particle diameter of from 10 to 80 nm. When the carbon is dispersed without aggregation, the surface roughness does not worsen. The second conductants have different particle diameters, and a large particle diameter worsens the surface roughness, resulting in filming, i.e., a toner or a paper powder anchor.

When greater than 100 μm, the surface roughness is not greater than 0.4 μm.

In this embodiment, the first and the second conductants have an average primary particle diameter not greater than 100 nm.

The electroconductive resin belt of embodiment 2-3 exerts the following effect in addition to the effects of the electroconductive belt of the embodiment 2-1 or 2-2.

(13) The first and the second conductants have an average primary particle diameter not greater than 100 nm to improve surface smoothness and glossiness, and decrease filming.

### Embodiment 2-4

Embodiment 2-4 is explained.

This embodiment is the electroconductive resin belt of the embodiment 2-2 or 2-3 except that the additive of the fifth group is blended in an amount of from 0.01 to 2.0% by weight.

When the additive of the fifth group is blended much, mechanical strength decreases, bleed out occurs, glossiness and images tend to deteriorate.

The additive of the fifth group is preferably blended in an amount of from 0.1 to 2.0% by weight, and more preferably from 0.2 to 1.0% by weight.

The electroconductive resin belt of embodiment 2-4 exerts the following effect in addition to the effects of the electroconductive belt of the embodiment 2-2 or 2-3.

(14) The additive of the fifth group is blended in an amount of from 0.01 to 2.0% by weight to decrease screw load, and therefore kneading and extrusion molding can stably be made. A suitable amount thereof prevents the glossiness from lowering to achieve targeted glossiness. Bleed out is prevented, and an electroconductive belt having high durability is provided.

### Embodiment 2-5

Embodiment 2-5 is explained.

This embodiment is the electroconductive resin belt of any one of the embodiments 2-1 to 1-4 except that at least one compatibilizer selected from the following sixth group is blended in an amount of from 0.1 to 2.0% by weight based on total weight of Si-O-PEI and the second group polymer.

(Sixth Group) Ethylene-glycidyl methacrylate copolymer and polymer including an oxazoline group.

The materials in the sixth group work as compatibilizers and can downsize the dispersion phase. The dispersion phase having a small size improves glossiness and surface roughness.

The electroconductive resin belt in this embodiment 2-5 has the micro-phase structure in FIG. 8. In FIG. 8, a compatibilizer 6 is further dispersed in that of FIG. 7.

When a compatibilizer is blended too much, mechanical strength lowers, bleed out occurs, and glossiness and images tend to deteriorate. The materials in the sixth group is blended in an amount of from 0.1 to 2.0% by weight.

The electroconductive resin belt of embodiment 2-5 exerts the following effect in addition to the effects of the electroconductive belt of any one of the embodiments 2-1 to 2-4.

(15) At least one compatibilizer selected from the following sixth group is blended in an amount of from 0.1 to 2.0% by weight, and preferably from 0.2 to 1.0% by weight based on total weight of PPS and Si-O-PEI to downsize the dispersion phase and form a uniform micro-phase separation structure.

### Embodiment 2-6

Embodiment 2-6 is explained.

This embodiment is the electroconductive resin belt of any one of the embodiments 2-1 to 2-5 except for having a volume resistivity at 100 V (Rv100 [Ω·cm]) of from 10⁸ to 10¹² [Ω·cm] and a surface resistivity of from at 500 V (Rv500 [Ω·cm]) of from 10⁸ to 10¹² [Ω/□].

The electroconductive resin belt of embodiment 2-6 exerts the following effect in addition to the effects of the electroconductive belt of any one of the embodiments 2-1 to 2-5.

(16) The electroconductive resin belt having the above electrical properties realizes an image forming apparatus producing high-quality images.

### Embodiment 2-7

Embodiment 2-7 is explained.

This embodiment is a method of preparing the electroconductive resin belt of any one of the embodiments 2-1 to 2-6.

The method includes (1) a process of pulverizing Si-O-PEI and the following second group polymer to form particles having an average particle diameter not greater than 300 μm, (2) a process of stirring the particles, carbon as a first conductant and at least one second conductant selected from the following third and fourth groups at a high speed of from 1,000 to 3,000 rpm, and melting and kneading the mixture at 260 to 330° C. to prepare a melted and kneaded mixture, and (3) a process of molding the melted and kneaded mixture by extrusion.

(Second Group) Polyester and aliphatic polyamide

(Third Group) Particulate Al-doped ZnO, particulate Ga-doped ZnO, particulate Sb-doped SnO₂, particulate In-doped SnO₂ and particulate P-doped SnO₂

(Fourth Group) Metal oxides coated with any one of the members of the third group

### Embodiment 2-7-1

Embodiment 2-7-1 is explained.

This embodiment is a method of preparing the electroconductive resin belt of any one of the embodiments 2-1 to 2-7.

The method includes (1) a process of pulverizing Si-O-PEI and the following second group polymer to form particles having an average particle diameter not greater than 300 μm, (2) a process of stirring the particles, carbon as a first conductant and at least one second conductant selected from the following third and fourth groups at a high speed of from 1,000 to 3,000 rpm, and melting and kneading the mixture at 260 to 330° C. to prepare a melted and kneaded mixture, (3) a process of stirring Si-O-PEI particles obtained in the process (1) and at least one second conductant selected from the third and fourth groups at a high speed of from 1,000 to 3,000 rpm, (4) a process of melting and kneading the melted and kneaded mixture and the mixture obtained in the process (2) and the mixture obtained in the process (3) at 290 to 330° C. to prepare a melted and kneaded mixture, and (5) a process of molding the melted and kneaded mixture obtained in the process (4) by extrusion.

(Second Group) Polyester and aliphatic polyamide

(Third Group) Particulate Al-doped ZnO, particulate Ga-doped ZnO, particulate Sb-doped SnO₂, particulate In-doped SnO₂ and particulate P-doped SnO₂

(Fourth Group) Metal oxides coated with any one of the members of the third group

The method of embodiment 2-7 and 2-7-1 exert the following effect.

(17) Polymer materials are pulverized and dispersed at high speed before kneaded to improve dispersibility of the conductants and achieve uniform electrical properties.

### Embodiment 2-8

Embodiment 2-8 is explained.

This embodiment is a method of preparing the electroconductive resin belt in addition to the method of the embodiment 2-7.

In the process of stirring the particle at a high speed of from 1,000 to 3,000 rpm, together with the first and the second conductants, at least one additive selected from the following fifth group or at least one additive selected from the following fifth group and at least one compatibilizer selected from the sixth group.

(Fifth Group) Silicone oil, metal soap, particulate polyimide and particulate silicone

(Sixth Group) Ethylene-glycidylmethacrylate copolymer and polymer including an oxazoline group

The method of embodiment 2-8 exerts the following effects.

(18) An additive such as silicone oil and a metal soap of the fifth group decreases screw load to stabilize kneading and extrusion molding.

(19) At least one compatibilizer selected from the sixth group downsizes the dispersion phase to form a uniform micro-phase separation structure.

### Embodiment 2-9

Embodiment 2-9 is explained.

In the molding process in the method of preparing the electroconductive resin belt of the embodiment 2-7 or 2-8, a cylindrical member called mandrel is located under a die, which cools the melted and kneaded material to have a temperature not higher than its glass transition temperature. FIG. 4 is a schematic view illustrating a circular die formed of a die and a mandrel when forming an electroconductive resin belt by extrusion molding. A mandrel 8 is located at the bottom of a spiral die 6 directly connected thereto. The mandrel 8 is connected with an oil temperature adjustor and the temperature thereof can be controlled. The mandrel has, e.g., a temperature not higher than a glass transition temperature of a polymer alloy, which is solidified while passing the mandrel 8 to have the same size (circumferential length) as a mandrel diameter 9. The mandrel 8 has many production advantages such as stable control of the size (circumferential length), less influence of outer air, less influence of oscillation and easier arrangements before preparation.

Considering properties of intermediate transfer belt, particularly reduction of anisotropy of electrical properties first, a die slip diameter 7 and the mandrel diameter 9 are preferably same. The mandrel diameter 9 can be controlled by about 10% less than the die slip diameter 7 without additional modification of a molder. It may be controlled by about 50% less than the die slip diameter 7 to reduce thickness deviation of intermediate transfer belt.

Embodiment 2-9 is a method of preparing an electroconductive resin belt using a circular die 10 in FIG. 4 in the molding process as embodiment 1-10.

The method of embodiment 2-9 exerts the following effects.

(20) The size and thickness deviation are easily controlled, and production reproducibility is high.

### Embodiment 2-10

This embodiment 2-10 is an image forming apparatus using any one of the electroconductive belt of the embodiments 2-1 to 2-6 in the embodiment 1-11.

### Embodiment 2-11

This embodiment 2-11 is an image forming apparatus using any one of the electroconductive belt of the embodiments 2-1 to 2-6 in the embodiment 1-12.

The image forming apparatuses of the embodiments 2-10 and 2-11 exert the following effect.

(21) The electroconductive belt of the present invention does not produce images having different properties even when transferred in various methods.

### Embodiment 3

In this embodiment, Si-O-PEI is used as the first resin and the following second group resin.

(Second Group) Polyetherimide and polyether sulfone

### Embodiment 3-1

Embodiment 3-1 is explained.

This embodiment alloys the second group polymer to Si-O-PEI to improve tensile elasticity, and further blends silicone oil, metal soap, particulate polyimide, particulate silicone, ethylene-glycidylmethacrylate copolymer and polymer including an oxazoline group when necessary to solve the above problems 1 to 8. As a result, an electroconductive resin belt preventing itself from breaking when running; solving problems of abnormal images such as filming (glossiness changes as images are produced), white spots, scattered images and void images; being easy to control properties and have reproducibility; being producible at low cost; and having flame resistance to comply with high-level safety demands. Typically, in a polymer alloy, a resin blended in a larger amount becomes a continuous phase (sea) 1 and a resin blended in a smaller amount becomes a dispersion phase (island) 2. In the present invention, Si-O-PEI is the continuous phase (sea) 1 and the second group polymer is the dispersion phase (island) 2.

### <Polyetherimide (PEI)>

Polyetherimide is a flame resistant amorphous polymer having the following formula (4).

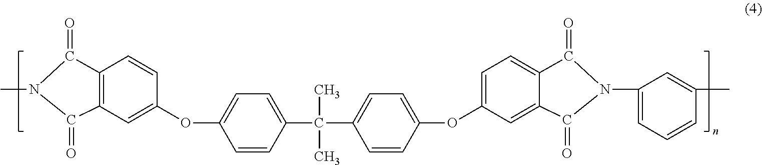

Polyetherimide has an imide bond having heat resistance and mechanical strength and an ether bond having good modifiability. As for mechanical strength, particularly it has good tensile elasticity of as high as 3,000 MPa. Having the same PEI structure, PEI and Si-O-PEI are likely to be uniformly mixed. Carbon is easily mixed as well.

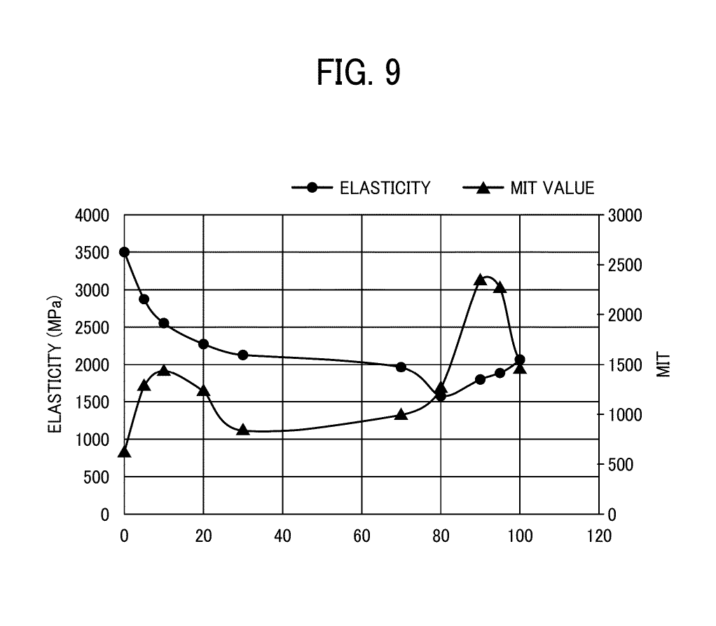

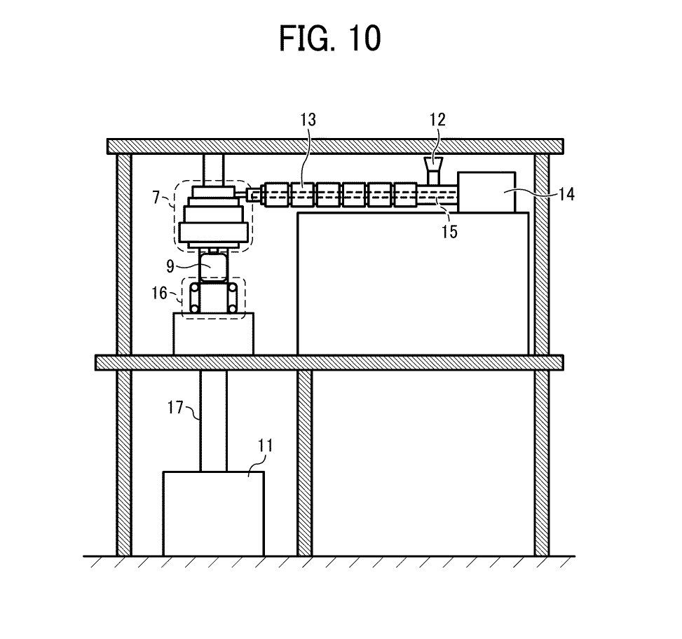

Mechanical properties (relativity between elasticity and MIT) when PEI is blended with Si-O-PEI are shown in FIG. 9. PEI improves elasticity, but tends to lower MIT value.

When the elasticity has a standard value not less than 1,000 MPa and a MIT value not less than 5,000 times, PEI is included in an amount of from 15 to 30% in consideration of lowering flame resistance. PEI has the most suitable (reference) range of amount although varied according to viscosity (MFI value) and molding conditions such as temperature, extrusion speed, and receiving speed and temperature.

Carbon 3 is unevenly distributed in either in case of polymer alloy, but is distributed in both of PEI and Si-O-PEI when normally kneaded because of having a similar structure.

Carbon unevenly distributed in a dispersion phase improves stability of electrical properties, particularly voltage dependency. In order to unevenly distribute carbon in a dispersion phase, it is mixed before kneaded, and other methods may be used.

In addition, both of PEI and Si-O-PEI have good affinity with the first conductant carbon 3, and therefore carbon 3 disperses well therein.

### <Polyether Sulfone (PES)>

Polyether sulfone is a flame resistant amorphous polymer having the following formula (5). It has good properties under high temperature, maintains the same strength as that at normal temperature until 200° C., varies less in size and is stable, and has good creep resistance, electrical properties and moldability until 180° C.

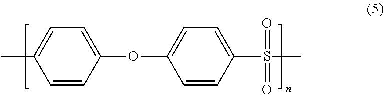

The polymer used as a material for the electroconductive belt improves mechanical properties, heat resistance and flame resistance more than before.

Typically, combinations of alloyed thermoplastic resins to improve mechanical properties are known. For example, when a small amount (3 to 20% by weight) of polyether imide which has low flex resistance (0.38 R) alone is blended with Si-O-PEI and alloyed, the flex resistance (0.38 R) is improved by 1.5 to 2.5 times, and mechanical properties is improved.

Since polyether imide is a flame resistant material, it has no problem of flame resistance when alloyed.

Further, Si-O-PEI and the second group polymer are alloyed to maintain flame resistance (VTM-0) and achieve a tensile elasticity not less than 1,000 MPa.

It is preferable that the second group polymer and carbon 3 are melted and kneaded to prepare melted and kneaded materials first, and next, the melted and kneaded materials, Si-O-PEI and the second conductant are melted and kneaded. The two-stage melting and kneading process improves dispersibility of the dispersion phase 2 to improve electrical properties and reduce aggregation of carbon.

### <Explanation of First Conductant Carbon>

Typically, an electroconductive carbon which is relatively inexpensive and less dependent on environment is preferably used. Carbon includes furnace black, channel black, acetylene black, Ketjenblack, etc., according to its production methods. Since the first group polymers of the present invention have a high molding temperature of 300° C., carbon having less volatile component is preferably used not to foam at high temperature. Carbon including a volatile component in an amount not greater than 2.0% when heated at 950° C. for 7 min is preferably used. The more the carbon, the lower the resistivity. The content of carbon to have a targeted resistivity depends on the kind of carbon, particularly on DBP (dibutylphthalate) amount (JISK6221).

The less the carbon, the more advantageous for mechanical properties and glossiness. The more the carbon, the lower the mechanical properties, the glossiness and the surface smoothness (mainly causing filming). Particularly, flex resistance largely lowers. Ketjenblack having a large DBP value is preferably used to have a targeted resistivity, but is not used often due to voltage dependency and poor reproducibility.

The voltage dependency is caused by different conductive paths due to voltage and influenced by carbon dispersion uniformity. Since more particles are preferably dispersed to decrease a difference of distance of the conductive paths in order to improve dispersion uniformity, furnace black or acetylene black having relatively a small DBP amount is used.

In the present invention, the carbon is closed in the dispersion phase (island) and difficult to transfer to improve voltage dependency and reproducibility. Therefore, Ketjenblack advantageously used for mechanical properties, glossiness and filming can be used. Further, a combination of Ketjenblack and large-size carbon improves surface forming stability and positional uneven volume resistivity.

### <Explanation of Second Conductant>

The carbon as the first conductant is an orienting material. The second group polymers, polyetherimide and polyether sulfone are amorphous materials and has no carbon orientation affected by crystallization as crystalline resins. However, carbon alone causes orientation because it tends to orient. Therefore, a second conductant which is not influenced by a polymer orientation and not unevenly distributed as carbon is studied in consideration of the above properties 1 to 8.

As a result, the second conductant is preferably at least one material selected from the following third and fourth groups.

(Second Group) Polyetherimide and polyether sulfone

(Third Group) Particulate Al-doped ZnO, particulate Ga-doped ZnO, particulate Sb-doped SnO₂, particulate In-doped SnO₂ and particulate P-doped SnO₂

(Fourth Group) Metal oxides coated with any one of the members of the third group

The second conductant preferably has an average primary particle diameter not greater than 100 nm, and more preferably from 10 to 50 nm. When larger than 100 nm, there are no problem of electrical properties, but surface smoothness deteriorates and filming tends to occur.

The electroconductive resin belt of this embodiment exerts the following effects.

(1) The second group polymer is alloyed with Si-O-PEI to improve flex resistance and tensile elasticity.

(2) Carbon conductant is unevenly distributed in or a circumference of a dispersion phase, a second conductant is present in both of a continuous phase and the dispersion phase, and the contents of the conductants are controlled to independently control the surface resistivity and the volume resistivity, and improve voltage dependency and targeted electrical properties can be achieved.

(3) A metal oxide having low hygroscopicity is used as the second conductant to provide an electroconductive belt satisfying environmental dependency of the resistivity.

(4) Carbon is unevenly distributed in a dispersion phase and closed therein to prepare an electroconductive resin belt having stable resistivity, influenced less by molding temperature and modification speed.

(5) Ketjenblack realizing resistivity in a small amount can be used because of being unevenly distributed in a dispersion phase and closed therein. Conductants are used less to prevent mechanical properties from lowering and improve flex resistance.

(6) All the constitutional materials have high flame resistance to provide an electroconductive resin belt having VTM-0 in UL94 standard.

(7) Low-cost carbon as well as metal oxide are used to provide an inexpensive electroconductive belt.
(8) Si-O-PEI improves surface smoothness, cleanability and prevention of filming.

### Embodiment 3-2

Embodiment 3-2 is explained.

This embodiment is an electroconductive resin belt including Si-O-PEI, the following second group polymer, carbon 3 as the first conductant, at least one second conductant selected from the following third group and the fourth group, and at least one additive selected from the following fifth group. Si-O-PEI forms a continuous phase 1, each the second group polymer forms a dispersion phase 2, the fifth group additive forms another dispersion phase 5, the carbon is unevenly distributed in the dispersion phase 2 of the second group polymer, the second conductant is present in both of the dispersion phase 2 and the continuous phase 1. The belt has a flame resistance of VTM-0 in UL94 standard when having a thickness of from 50 to 150 μm.

(Second Group) Polyetherimide and polyether sulfone

(Third Group) Particulate Al-doped ZnO, particulate Ga-doped ZnO, particulate Sb-doped SnO₂, particulate In-doped SnO₂, particulate P-doped SnO₂,

(Fourth Group) Metal oxides coated with any one of the members of the third group

(Fifth Group) Silicone oil and metal soap

In order to improve the above 7 molding stability, a screw load of the molder is effectively reduced. Silicone oils such as dimethyl silicone, methyl phenyl silicone, methyl hydrogen silicone and circular dimethyl silicone are effectively used to reduce the screw load. Particularly, methyl phenyl silicone and methyl hydrogen silicone are preferably used.

In addition, silicone oil is preferably used to improve the above 5 abnormal images: filming.

A metal soap exerts the same effect as that of silicone oil.

Specific examples of the metal soap include, but are not limited to, metal salt stearate, metal salt 12 hydroxy stearate, metal salt montanate, metal salt behenate and metal salt laurate. Metal soaps which do not deteriorate with heat, i.e., a molding temperature of from 260 to 340° C. of Si-O-PEI and the second group polymer are preferably used. For example, lithium stearate, calcium montanate, lithium montanate, and sodium 12 hydroxy stearate, etc. are preferably used.

In addition to the above effects (1) to (8) of the electroconductive belt of embodiment 3-1, the electroconductive resin belt of embodiment 3-2 exerts the following effects.

(9) Silicone oil and metal soap are blended to reduce filming on the surface of the belt, and a belt having high durability can be provided.

(10) Silicone oil and metal soap are blended to stabilize extrusion moldability and decrease resin pressure variation.

### Embodiment 3-3

Embodiment 3-3 is explained.

This embodiment is the electroconductive resin belt of the embodiments 3-1 or 3-2 except that the second group polymer is blended to Si-O-PEI in an amount of from 3 to 40% by weight.

Since Si-O-PEI and the second group polymer are incompatible with each other, second group polymer forms a micro-phase separation structure as a dispersion phase 2 (island). The larger the dispersion phase 2, the lower the surface glossiness. As mentioned above, carbon 3 is unevenly distributed to second group polymer in the dispersion phase 2. The voltage dependency tends to lower when an amount of the second group polymer is large.

In addition to the effects of the electroconductive belt of embodiments 3-1 and 3-2, the electroconductive resin belt of embodiment 3-3 exerts the following effects.

(10) The second group polymer is blended to Si-O-PEI in an amount of from 3 to 40% by weight to prevent the glossiness from lowering and achieve targeted glossiness.

(11) The second group polymer is blended to Si-O-PEI in an amount of from 3 to 40% by weight to expect improvement of flex resistance.

### Embodiment 3-4

Embodiment 3-4 is explained.

This embodiment is the electroconductive resin belt of any one of the embodiments 3-1 to 3-3 except that the first and the second conductants have an average primary particle diameter not greater than 100 nm.

Electroconductive carbon has a particle diameter of from 10 to 80 nm. When the carbon is dispersed without aggregation, the surface roughness does not worsen. The second conductants have different particle diameters, and a large particle diameter worsens the surface roughness, resulting in filming, i.e., a toner or a paper powder anchor.

When greater than 100 μm, the surface roughness is not greater than 0.4 μm.

In this embodiment, the first and the second conductants have an average primary particle diameter not greater than 100 nm.

The electroconductive resin belt of embodiment 3-4 exerts the following effect in addition to the effects of the electroconductive belt of any one of the embodiments 3-1 to 3-4.

(12) The first and the second conductants have an average primary particle diameter not greater than 100 nm to improve surface smoothness and glossiness, and decrease filming.

### Embodiment 3-5

Embodiment 3-5 is explained.

This embodiment is the electroconductive resin belt of any one of the embodiments 3-2 to 3-4 except that the additive of the fifth group is blended in an amount of from 0.1 to 2.0% by weight, and preferably from 0.2 to 1.0% by weight based on total weight of Si-O-PEI and the second group polymer.

The electroconductive resin belt in this embodiment has the micro-phase structure in FIG. 7.

When the additive of the fifth group is blended much, mechanical strength decreases, bleed out occurs, glossiness and images tend to deteriorate.

The additive of the fifth group is preferably blended in an amount of from 0.1 to 2.0% by weight, and more preferably from 0.2 to 1.0% by weight.

The electroconductive resin belt of embodiment 3-5 exerts the following effect in addition to the effects of the electroconductive belt of any one of the embodiments 3-2 to 3-4.

(13) The additive of the fifth group such as silicone oil and metal soap and is blended in an amount of from 0.1 to 2.0% by weight, and preferably from 0.2 to 1.0% by weight to decrease screw load, and therefore kneading and extrusion molding can stably be made. A suitable amount thereof prevents the glossiness from lowering to achieve targeted glossiness. Bleed out is prevented, and an electroconductive belt having high durability is provided.

### Embodiment 3-6

Embodiment 1-6 is explained.

This embodiment is the electroconductive resin belt of any one of the embodiments 3-1 to 3-5 except that at least one compatibilizer selected from the following sixth group is blended in an amount of from 0.1 to 2.0% by weight, and preferably from 0.2 to 1.0% by weight based on total weight of Si-O-PEI and the second group polymer.

(Sixth Group) Ethylene-glycidyl methacrylate copolymer and polymer including an oxazoline group.

The electroconductive resin belt in this embodiment has the micro-phase structure in FIG. 8.

The materials in the sixth group work as compatibilizers and can downsize the dispersion phase. The dispersion phase having a small size improves glossiness and surface roughness. When a compatibilizer is blended too much, mechanical strength lowers, bleed out occurs, and glossiness and images tend to deteriorate. The materials in the sixth group is preferably blended in an amount of from 0.1 to 2.0% by weight, and more preferably from 0.2 to 1.0% by weight.

The electroconductive resin belt of embodiment 3-6 exerts the following effect in addition to the effects of the electroconductive belt of any one of the embodiments 3-1 to 3-5.

(14) At least one compatibilizer selected from the following sixth group is blended in an amount of from 0.1 to 2.0% by weight, and preferably from 0.2 to 1.0% by weight based on total weight of Si-O-PEI and the second group polymer to downsize the dispersion phase and form a uniform micro-phase separation structure.

### Embodiment 3-7

Embodiment 3-7 is explained.

This embodiment is the electroconductive resin belt of any one of the embodiments 3-1 to 3-6 except for having a volume resistivity at 100 V (Rv100 [Ω·cm]) of from 10⁸ to 10¹² [Ω·cm] and a surface resistivity of from at 500 V (Rv500 [Ω·cm]) of from 10⁸ to 10¹² [Ω/□].

The electroconductive resin belt of embodiment 3-7 exerts the following effect in addition to the effects of the electroconductive belt of any one of the embodiments 3-1 to 3-6.

(15) The electroconductive resin belt having the above electrical properties realizes an image forming apparatus producing high-quality images.

### Embodiment 3-8

Embodiment 3-8 is explained.

This embodiment is a method of preparing the electroconductive resin belt of any one of the embodiments 3-1 to 3-7.

The method includes (1) a process of pulverizing Si-O-PEI and the second group polymer to form particles having an average particle diameter not greater than 300 μm, (2) a process of stirring the particles, carbon as a first conductant and at least one second conductant selected from the following third and fourth groups at a high speed of from 1,000 to 3,000 rpm, and melting and kneading the mixture at 260 to 330° C. to prepare a melted and kneaded mixture, and (3) a process of molding the melted and kneaded mixture by extrusion.

(Second Group) Polyetherimide and polyether sulfone

(Third Group) Particulate Al-doped ZnO, particulate Ga-doped ZnO, particulate Sb-doped SnO₂, particulate In-doped SnO₂ and particulate P-doped SnO₂

(Fourth Group) Metal oxides coated with any one of the members of the third group

### Embodiment 3-9

Embodiment 3-9 is explained.

This embodiment is a method of preparing the electroconductive resin belt of any one of the embodiments 3-1 to 3-7.

The method includes (1) a process of pulverizing Si-O-PEI and the following second group polymer to form particles having an average particle diameter not greater than 300 μm, (2) a process of stirring the particles, carbon as a first conductant and at least one second conductant selected from the following third and fourth groups at a high speed of from 1,000 to 3,000 rpm, and melting and kneading the mixture at 260 to 330° C. to prepare a melted and kneaded mixture, (3) a process of stirring Si-O-PEI particles obtained in the process (1) and at least one second conductant selected from the third and fourth groups at a high speed of from 1,000 to 3,000 rpm, (4) a process of melting and kneading the melted and kneaded mixture and the mixture obtained in the process (2) and the mixture obtained in the process (3) at 290 to 330° C. to prepare a melted and kneaded mixture, and (5) a process of molding the melted and kneaded mixture obtained in the process (4) by extrusion.

(Second Group) Polyetherimide and polyether sulfone

(Third Group) Particulate Al-doped ZnO, particulate Ga-doped ZnO, particulate Sb-doped SnO₂, particulate In-doped SnO₂ and particulate P-doped SnO₂

(Fourth Group) Metal oxides coated with any one of the members of the third group

The method of embodiment 3-8 and 3-9 exert the following effect.

(16) Polymer materials are pulverized and dispersed at high speed before kneaded to improve dispersibility of the conductants and achieve uniform electrical properties.

### Embodiment 3-10

Embodiment 3-10 is explained.

This embodiment is a method of preparing the electroconductive resin belt in addition to the methods of the embodiments 3-8 and 3-9.

In the process of stirring the particle at a high speed of from 1,000 to 3,000 rpm, together with the first and the second conductants, at least one additive selected from the following fifth group or at least one additive selected from the following fifth group and at least one compatibilizer selected from the sixth group.

(Fifth Group) Silicone oil, metal soap, particulate polyimide and particulate silicone

(Sixth Group) Ethylene-glycidylmethacrylate copolymer and polymer including an oxazoline group

The method of embodiment 3-10 exerts the following effects.

(17) An additive such as silicone oil and a metal soap of the fifth group decreases screw load to stabilize kneading and extrusion molding.

(18) At least one compatibilizer selected from the sixth group downsizes the dispersion phase to form a uniform micro-phase separation structure.

### Embodiment 3-11

Embodiment 3-11 is explained.

In the molding process in the method of preparing the electroconductive resin belt of the embodiment 3-8 or 3-9, a cylindrical member called mandrel is located under a die, which cools the melted and kneaded material to have a temperature not higher than its glass transition temperature.

As a molder, the molder in which a cylindrical member called mandrel is located under a die used in the embodiment 1-10 can be used.

The method of embodiment 3-11 exerts the following effects.

(19) The size and thickness deviation are easily controlled, and production reproducibility is high.

### Embodiment 3-12

This embodiment 3-12 is an image forming apparatus using any one of the electroconductive belt of the embodiments 3-1 to 3-7 in the embodiment 1-11.

### Embodiment 3-13

This embodiment 3-13 is an image forming apparatus using any one of the electroconductive belt of the embodiments 3-1 to 3-7 in the embodiment 1-12.

The image forming apparatuses of the embodiments 3-12 and 3-13 exert the following effect.

(20) The electroconductive belt of the present invention does not produce images having different properties even when transferred in various methods.

### Embodiment 4

As a first resin, a semi-aromatic crystalline thermoplastic polyimide having a melting point not higher than 360° C. is used, and the following second group resin.

(Second Group) Polyetherimide and thermoplastic polyamideimide

### Embodiment 4-1

### Semi-Aromatic Crystalline Thermoplastic Polyimide

First, the semi-aromatic crystalline thermoplastic polyimide is explained.

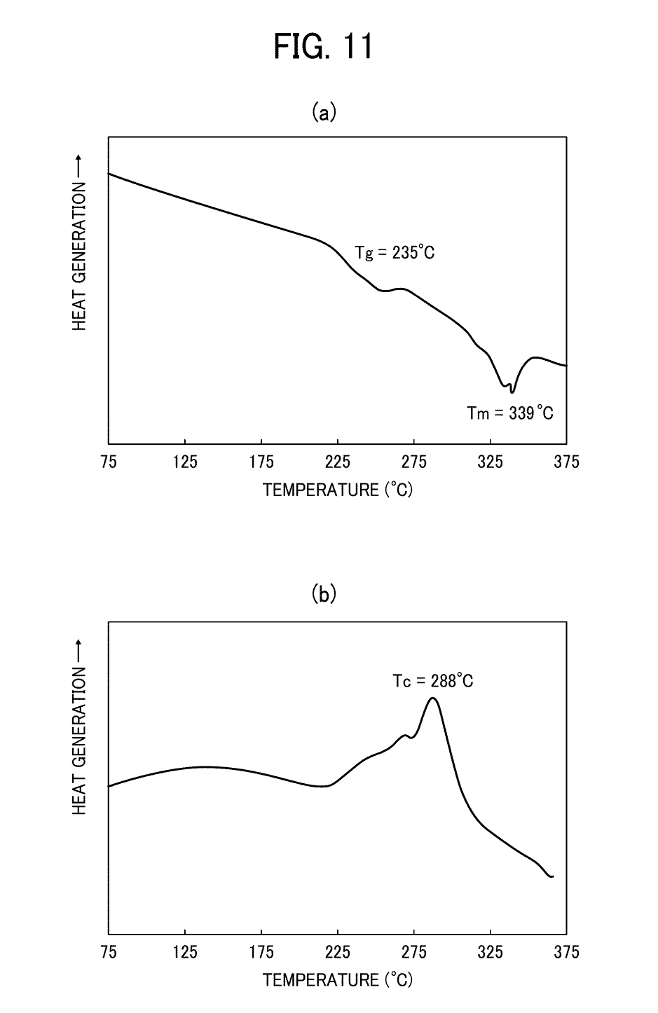

FIG. 11 is a diagram showing an example of a DSC curve of a semi-aromatic crystalline thermoplastic polyimide.

FIG. 11 (a) is a DCS curve in heating, and FIG. 11 (b) is a DSC curve in cooling. Tg represents a glass transition temperature, Tm represents a melting point, and Tc represents a crystallizing temperature.

As FIG. 11 (a) shows, the semi-aromatic crystalline thermoplastic polyimide has a low melting point of 360° C. and can be modified by typical equipment. Conventional thermoplastic polyimide has a high modifying temperature about 400° C., and modification requires very expansive specific equipment. Having a modifying temperature similar to those of polyetherimide and thermoplastic polyamideimide, the semi-aromatic crystalline thermoplastic polyimide can be alloyed therewith.

<Polyetherimide>

Polyetherimide is a flame resistant amorphous polymer having the formula (4).

Polyetherimide has an imide bond having heat resistance and mechanical strength and an ether bond having good modifiability. As for mechanical strength, particularly it has good tensile elasticity of as high as 3,000 MPa.

### <Thermoplastic Polyamideimide>

The thermoplastic polyamide is, e.g., an amorphous polymer having the following formula (6).

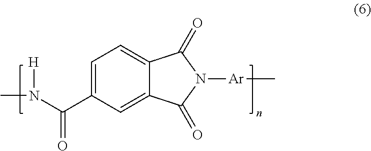

The polyamideimides differ according to the kinds thereof, but typically have good strength, toughness and abrasion resistance, but poor flex resistance. Further, it needs heating for a long time after molded, which costs very much.

Typically, combinations of alloyed thermoplastic resins to improve mechanical properties are known. For example, when a small amount (3 to 20% by weight) of polyether imide which has low flex resistance (0.38 R) alone is blended with the semi-aromatic crystalline thermoplastic polyimide and alloyed, the flex resistance (0.38 R) is improved by 1.5 to 2.5 times, and mechanical properties is improved.

The electroconductive resin belt of embodiment 4-1 improves in flex resistance and mechanical properties. Using low-cost carbon, an inexpensive electroconductive belt having electrical properties less dependent on environment can be provided.

The electroconductive resin belt of embodiment 4 has the same micro-phase structure shown in FIG. 1.

In FIG. 1, the dispersion phase 2 of the second group polymer is dispersed in the continuous phase 1 of the semi-aromatic crystalline thermoplastic polyimide, and the carbon black 3 is unevenly distributed in the dispersion phase 2.

The electroconductive resin belt of this embodiment exerts the following effects.

(1) Carbon is unevenly distributed in the dispersion phase, and the contents of the conductants are controlled to independently control the surface resistivity and the volume resistivity, and improve voltage dependency and targeted electrical properties can be achieved.

(2) Carbon is unevenly distributed in a dispersion phase and closed therein to prepare an electroconductive resin belt having stable resistivity, influenced less by molding temperature and modification speed.

(3) An inorganic conductant having low hygroscopicity is used as the second conductant to provide an electroconductive belt satisfying environmental dependency of the resistivity.

(4) Ketjenblack realizing resistivity in a small amount can be used because of being unevenly distributed in a dispersion phase and closed therein. Conductants are used less to prevent mechanical properties from lowering and improve flex resistance.

### Embodiment 4-2

Embodiment 4-2 is explained.

This embodiment is a method of preparing an electroconductive resin belt using the two-stage melting and kneading process, which includes (1) a process of melting and kneading at least one member of the second group and a conductant at from 350 to 400° C. to prepare a melted and kneaded material, (2) a process of melting and kneading the melted and kneaded material and the semi-aromatic crystalline thermoplastic polyimide having a melting point not higher than 360° C. at from 350 to 400° C. to prepare a melted and kneaded material, and (3) a process of molding the melted and kneaded mixture by extrusion.

### <Melting and Kneading Process>

Melting and kneading process is not particularly limited, and can be performed using, e.g., kneaders such as a monoaxial extruder, a biaxial extruder, a Bumbury's Mixer, a roll and a kneader.

### <Extrusion Molding Process>

As a molder, the molder in which a cylindrical member called mandrel is located under a die used in the embodiment 1-10 can be used.

### <Other Processes>

Other processes are not particularly limited, and include a cutting process, a washing process, a trimming process, etc.

The electroconductive resin belt of embodiment 4-2 exerts the following effects.

(1) The electroconductive resin belt having the above electrical properties realizes an image forming apparatus producing high-quality images.

(2) Carbon aggregation is reduce to improve surface glossiness (smoothness).

### Embodiment 4-3

This embodiment 4-3 is an image forming apparatus using the electroconductive belt of the embodiment 4-1 in the embodiment 1-11.

### Embodiment 4-4

This embodiment 4-4 is an image forming apparatus using the electroconductive belt of the embodiment 4-1 in the embodiment 1-12.

### EXAMPLES

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

Evaluation methods follow.

### [Mechanical Properties]

(1) Flex resistance (MIT test)

Test was made according to JIS-P8115. Not less than 2,000 times (Film thickness 90±10 μm) was good, and others were poor.

(2) Tensile elasticity

Test was made according to JIS-K7127. Not less than 1,000 MPa was good, and others were poor.

### [Electrical Properties]

(1) Surface resistivity

10⁸ to 10¹²Ω/□ under arbitrarily voltage from 100 to 500 V was good, and others were poor.

(2) Volume resistivity

10⁸ to 10¹²Ω/□ under arbitrarily voltage from 100 to 250 V was good, and others were poor.

(3) Surface resistivity (voltage dependency)

A difference between a surface resistivity measured at 100 V and that at 500 V was within single digits was good, and others were poor.

(4) Volume resistivity (voltage dependency)

A difference between a volume resistivity measured at 100 V and that at 250 V was within double digits was good, and others were poor.

(5) Surface resistivity/Environmental dependency

A difference between a surface resistivity measured at 10° C.10% and that at 30° C. 90% was within 0.5 digits was good, and others were poor.

(6) Volume resistivity/Environmental dependency

A difference between a volume resistivity measured at 10° C.10% and that at 30° C. 90% was within single digits was good, and others were poor.

### [Flame Resistance]

VTM-0 at the UL95 standard was good, and others were poor.

### [Surface Smoothness]

Not less than 70 at 20° glossiness (PGII from NIPPON DENSHOKU INDUSTRIES CO., LTD) was good, and others were poor.

### [Resistivity Controllability]

A variation ratio [Log Ω·cm/° C.] of the volume resistivity according to the molding temperature is not greater than 0.2 was good, and others were poor.

### [Molding Stability]

A variation width of molding resin pressure by an extruder having a die diameter of 310 mm was not greater than 10% was good, and others were poor.

### [Handleability]

A belt having no concave and convex defects such as kinks and dents when installed in and removed from an image forming apparatus imagio MP C2200 from Ricoh Company, Ltd. was good, and others were poor.

### [Image Evaluation]

No abnormalities such as transfer rate deterioration, increase of current leakage, defective cleaning, filming, edge crack and abnormal images was good, and others were poor.

### [Uneven Distributability of Carbon]

A ratio of the number of carbons present along the shape of a dispersion phase in 9 μm² to the number thereof present in the dispersion phase or at a circumferential arc thereof.

### Examples 1-1 to 1-8 and Comparative Examples 1-1 to 1-15

First, resin materials shown in Table 1 were pulverized by a pulverizer from Seishin Enterprise Co., Ltd.

Next, other components shown in Table 1 were added to the pulverized particles, and mixed and stirred at 2,000 rpm for 3 min by a high-speed stirrer from Mitsui Mining Co., Ltd. to prepare a mixture for molding.

The mixture for molding was melted and kneaded at 300° C. by a biaxial extrusion kneader (L/D=60) to prepare a pellet.

The pellet was subjected to extrusion molding at 300° C. using a circular die in FIG. 5 to prepare an electroconductive resin belt having an inner diameter of 250 mm and a width of 235 mm.

The above properties of each of the electroconductive resin belts prepared in Examples 1-1 to 1-8 and Comparative Examples 1-1 to 1-15 were evaluated. The results are shown in Table 1.

### Examples 2-1 to 2-4 and Comparative Examples 2-1 to 2-7

First, resin materials shown in Table 2 were pulverized by a pulverizer from Seishin Enterprise Co., Ltd.

Next, other components shown in Table 2 were added to the pulverized particles, and mixed and stirred at 2,000 rpm for 3 min by a high-speed stirrer from Mitsui Mining Co., Ltd. to prepare a mixture for molding.

The mixture for molding was melted and kneaded at 300° C. by a biaxial extrusion kneader (L/D=60) to prepare a pellet.

The pellet was subjected to extrusion molding at 300° C. using a circular die in FIG. 5 to prepare an electroconductive resin belt having an inner diameter of 310 mm and a width of 235 mm.

The above properties of each of the electroconductive resin belts prepared in Examples 2-1 to 2-4 and Comparative Examples 2-1 to 2-7 were evaluated. The results are shown in Table 2.

### Examples 3-1 to 3-13 and Comparative Examples 3-1 to 3-15

First, resin materials shown in Table 3 were pulverized by a pulverizer from Seishin Enterprise Co., Ltd.

Next, other components shown in Table 3 were added to the pulverized particles, and mixed and stirred at 2,000 rpm for 3 min by a high-speed stirrer from Mitsui Mining Co., Ltd. to prepare a mixture for molding.

The mixture for molding was melted and kneaded at 300° C. by a biaxial extrusion kneader (L/D=60) to prepare a pellet.

The pellet was subjected to extrusion molding at 300° C. using a circular die in FIG. 5 to prepare an electroconductive resin belt having an inner diameter of 310 mm and a width of 235 mm.

The extrusion molding method is explained further in detail, based on FIG. 10.

First, a pellet-shaped resin and a powder-shaped resin are provided from a material feeding opening called hopper 812. They are fed by natural fall due to their own weights or by a measurement feeder (unillustrated) in a constant amount.

Next, a motor for rotating screw 14 rotates a screw 15 in a barrel 13 at a predetermined rotational number.

The screw 15 is typically monoaxial or biaxial according to a resin used therefor.

The screw 15 has continuous groove shapes suitable for resin used on the surface of a metallic cylinder, and feeds (resins to extruding side), kneads (mixes resins), compresses (melts resins with shearing strength), and measures (stabilizes an extruding amount per time unit) materials fed in the barrel 13. The barrel 13 is formed of independently-controllable parts.

The melted and kneaded resins are injected into a die 7 with a pressure of materials placed afterwards. The die 7 is formed of independently-controllable parts as well as the barrel 13. The melted resins pass the die 7 and are extruded from a die slip (die exit) in the shape of a tube. The extruded resins is formed to a belt (tube) having a desired diameter by a mandrel 9 and cooled. The mandrel is controlled to have a constant temperature. Typically, the temperature of the barrel 13 is controlled by an electrical heater, and those of the die 7 and the mandrel 9 are controlled by an electrical heater or a fluid (water and oil) according to ranges of temperatures used. In the present invention, the temperature of the barrel 13 and the die 7 are controlled by an electrical heater, and the mandrel 9 by oil. The resins cooled by the mandrel is transferred below by a receiver 16. A transferred resin tube 17 is fed to a second modifier 11 is cut to from a belt having desired sizes. Molding methods are not limited to the extrusion molding method, and other molding methods such as inflation molding methods can be used.

The above properties of each of the electroconductive resin belts prepared in Examples 3-1 to 3-13 and Comparative Examples 3-1 to 3-15 were evaluated. The results are shown in Table 3.

### Examples 4-1 to 4-7 and Comparative Examples 4-1 to 4-6

First, resin components in Table 4 were kneaded at 355° C. by a biaxial extrusion kneader (L/D=60) to prepare a pellet.

The pellet was subjected to extrusion molding at 350° C. using a circular die in FIG. 5 to prepare an electroconductive resin belt having an inner diameter of 310 mm and a width of 235 mm.

The above properties of each of the electroconductive resin belts prepared in Examples 4-1 to 4-7 and Comparative Examples 4-1 to 4-6 were evaluated. The results are shown in Table 4.

TABLE 1

| | | MFI | Examples | | | |
|---|---|---|---|---|---|---|
| | | value | 1-1 | 1-2 | 1-3 | 1-4 |
| PPS | T1881-3 | 70 | | | 92 | 90 |
| | (Toray) | | | | | |
| | W300 (Poly- | 60 | 95 | 90 | | |
| | plastics) | | | | | |
| Si—O-PEI | STM1500 | 12 | 5 | 10 | | 10 |
| | (SABIC) | | | | | |
| | STM1700 | 7 | | | 8 | |
| | (SABIC) | | | | | |
| First | Acetylene | — | 11.5 | 11.5 | | 11.5 |
| Conductant | Black | | | | | |
| | Ketjenblack | — | | | 2.5 | |
| Second | Al-doped | — | 4 | | 15 | |
| Conductant | ZnO | | | | | |
| | Ga-doped | — | | 4 | | 4 |
| | ZnO | | | | | |
| | Sb-doped | — | | | | |
| | SnO₂ | | | | | |
| | TiO₂ coated | — | | | | |
| | with Sb- | | | | | |
| | doped SnO₂ | | | | | |
| Silicone | Methyl | — | 1 | 0.8 | 1 | 0.5 |
| Oil | Phenyl | | | | | |
| | Siloxane Oil | | | | | |
| Metal Soap | Ca | — | | | 1 | 0.5 |
| | Montanate | | | | | |
| Additive | Li Stearate | — | 0.5 | 0.8 | | |
| Compatibi- | Ethylene- | — | | 1 | 0 | 1 |
| lizer | Glycidyl | | | | | |
| | Acrylate | | | | | |
| | Copolymer | | | | | |
| | Oxazolines | — | | | | |
| Thickness | μm | — | 85 ± 9 | 91 ± 10 | 95 ± 10 | 90 ± 8 |
| Mechanical | (1) | — | Good | Good | Good | Good |
| Properties | (2) | — | Good | Good | Good | Good |
| Electrical | (1) | — | Good | Good | Good | Good |
| Properties | (2) | — | Good | Good | Good | Good |
| | (3) | — | Good | Good | Good | Good |
| | (4) | — | Good | Good | Good | Good |
| | (5) | — | Good | Good | Good | Good |
| | (6) | — | Good | Good | Good | Good |

| | | | | | |
|---|---|---|---|---|---|
| Flame Resistance | — | Good | Good | Good | Good |
| VTM-0 | | | | | |
| Surface Smoothness | — | Good | Good | Good | Good |
| Resistivity | — | Good | Good | Good | Good |
| Controllability | | | | | |
| Molding Stability | — | Good | Good | Good | Good |
| Handle ability | — | Good | Good | Good | Good |
| Image Evaluation | — | Good | Good | Good | Good |

| | | Examples | | | |
|---|---|---|---|---|---|
| | | 1-5 | 1-6 | 1-7 | 1-8 |
| PPS | T1881-3 | 95 | | | 50 |
| | (Toray) | | | | |
| | W300 (Poly- | | 95 | 90 | 43 |
| | plastics) | | | | |
| Si—O-PEI | STM1500 | | 5 | 10 | 7 |
| | (SABIC) | | | | |
| | STM1700 | 5 | | | |
| | (SABIC) | | | | |
| First | Acetylene | 3 | 11 | 10.5 | 7.5 |
| Conductant | Black | | | | |
| | Ketjenblack | | | | 1.5 |
| Second | Al-doped | | | | |
| Conductant | ZnO | | | | |
| | Ga-doped | | | | |
| | ZnO | | | | |
| | Sb-doped | 15 | | 3 | |
| | SnO₂ | | | | |
| | TiO₂ coated | | 5 | | |
| | with Sb- | | | | |
| | doped SnO₂ | | | | |
| Silicone | Methyl | 0.5 | 0.5 | 0.5 | |
| Oil | Phenyl | | | | |
| | Siloxane Oil | | | | |
| Metal Soap | Ca | | | | |
| | Montanate | | | | |
| Additive | Li Stearate | 0.5 | 0.5 | 0.5 | |
| Compatibi- | Ethylene- | | | | |
| lizer | Glycidyl | | | | |
| | Acrylate | | | | |
| | Copolymer | | | | |
| | Oxazolines | | 1 | 1 | |
| Thickness | μm | 96 ± 9 | 96 ± 7 | 95 ± 10 | 88 ± 4 |
| Mechanical | (1) | Good | Good | Good | Good |
| Properties | (2) | Good | Good | Good | Good |
| Electrical | (1) | Good | Good | Good | Good |
| Properties | (2) | Good | Good | Good | Good |
| | (3) | Good | Good | Good | Good |
| | (4) | Good | Good | Good | Good |
| | (5) | Good | Good | Good | Good |
| | (6) | Good | Good | Good | Good |
| Flame Resistance | | Good | Good | Good | Good |
| VTM-0 | | | | | |
| Surface Smoothness | | Good | Good | Good | Good |
| Resistivity | | Good | Good | Good | Good |
| Controllability | | | | | |
| Molding Stability | | Good | Good | Good | Good |
| Handle ability | | Good | Good | Good | Good |
| Image Evaluation | | Good | Good | Good | Good |
| | | Comparative Examples | | | |
| | | 1-1 | 1-2 | 1-3 | 1-4 |
| PPS | T1881-3 | 100 | | | 95 |
| | (Toray) | | | | |
| | W300 (Poly- | | 100 | | |
| | plastics) | | | | |
| Si—O-PEI | STM1500 | | | 100 | |
| | (SABIC) | | | | |
| | STM1700 | | | | 5 |
| | (SABIC) | | | | |
| First | Acetylene | 13.5 | 12.5 | 12.5 | 11.5 |
| Conductant | Black | | | | |
| | Ketjenblack | | | | |
| Second | Al-doped | | 4 | 4 | 4 |
| Conductant | ZnO | | | | |
| | Ga-doped | | | | |
| | ZnO | | | | |
| | Sb-doped | | | | |
| | SnO₂ | | | | |
| | TiO₂ coated | | | | |
| | with Sb- | | | | |
| | doped SnO₂ | | | | |
| Silicone Oil | Methyl | | 0.5 | 0.5 | 2 |
| | Phenyl | | | | |
| | Siloxane Oil | | | | |
| Metal Soap | Ca | | | | |
| | Montanate | | | | |
| Additive | Li Stearate | 1 | 1 | 1 | 3 |
| Compatibi- | Ethylene- | | | | |
| lizer | Glycidyl | | | | |
| | Acrylate | | | | |
| | Copolymer | | | | |
| | Oxazolines | | | | |
| Thickness | μm | 90 ± 12 | 88 ± 9 | 89 ± 9 | 97 ± 8 |
| Mechanical | (1) | Poor | Good | Poor | Good |
| Properties | (2) | Good | Good | Poor | Good |
| Electrical | (1) | Good | Good | Good | Good |
| Properties | (2) | Poor | Poor | Good | Good |
| | (3) | Poor | Good | Good | Good |
| | (4) | Poor | Good | Good | Good |
| | (5) | Good | Good | Good | Good |
| | (6) | Good | Good | Good | Good |

| | | | | |
|---|---|---|---|---|
| Flame Resistance | Good | Good | Good | Good |
| VTM-0 | | | | |
| Surface Smoothness | Good | Good | Good | Poor |
| Resistivity | Poor | Good | Good | Good |
| Controllability | | | | |
| Molding Stability | Poor | Good | Good | Good |
| Handle ability | Poor | Poor | Good | Good |
| Image Evaluation | Poor | Good | Poor | Good |

Comparative Examples

| | | 1-5 | 1-6 | 1-7 | 1-8 |
|---|---|---|---|---|---|
| PPS | T1881-3 | 95 | 95 | | |
| | (Toray) | | | | |
| | W300 (Poly- | | | 95 | 90 |
| | plastics) | | | | |
| Si—O-PEI | STM1500 | | | 5 | 10 |
| | (SABIC) | | | | |
| | STM1700 | 5 | 5 | | |
| | (SABIC) | | | | |
| First | Acetylene | 11.5 | 11.5 | 11.5 | 12 |
| Conductant | Black | | | | |
| | Ketjenblack | | | | |
| Second | Al-doped | | | | |
| Conductant | ZnO | | | | |
| | Ga-doped | | | | |
| | ZnO | | | | |
| | Sb-doped | | | | 4 |
| | SnO₂ | | | | |
| | TiO₂ coated | | | | |
| | with Sb- | | | | |
| | doped SnO₂ | | | | |
| Silicone | Methyl | 3 | 4 | 1 | 0.5 |
| Oil | Phenyl | | | | |
| | Siloxane Oil | | | | |
| Metal Soap | Ca | 0.5 | 0.5 | 1 | |
| | Montanate | | | | |
| Additive | Li Stearate | | | | 0.5 |
| Compatibi- | Ethylene- | | | | 2 |
| lizer | Glycidyl | | | | |
| | Acrylate | | | | |
| | Copolymer | | | | |
| | Oxazolines | | | | |
| Thickness | μm | | | | |
| Mechanical | (1) | Good | Good | Good | Good |
| Properties | (2) | Good | Good | Good | Good |
| Electrical | (1) | Good | Good | Good | Good |
| Properties | (2) | Poor | Poor | Poor | Good |
| | (3) | Poor | Poor | Poor | Good |
| | (4) | Poor | Poor | Poor | Good |
| | (5) | Good | Good | Good | Poor |
| | (6) | Good | Good | Good | Good |

| | | | | |
|---|---|---|---|---|
| Flame Resistance | Good | Good | Good | Good |
| VTM-0 | | | | |
| Surface Smoothness | Poor | Poor | Good | Poor |
| Resistivity | Good | Good | Good | Good |
| Controllability | | | | |
| Molding Stability | Good | Good | Good | Good |
| Handle ability | Good | Good | Good | Good |
| Image Evaluation | Good | Good | Good | Poor |

Comparative Examples

| | | 1-9 | 1-10 | 1-11 | 1-12 |
|---|---|---|---|---|---|
| PPS | T1881-3 | | 85 | 70 | 80 |
| | (Toray) | | | | |
| | W300 (Poly- | 90 | | | |
| | plastics) | | | | |
| Si—O-PEI | STM1500 | 10 | 15 | 30 | 20 |
| | (SABIC) | | | | |
| | STM1700 | | | | |
| | (SABIC) | | | | |
| First | Acetylene | 12 | 12 | 11.5 | 11.5 |
| Conductant | Black | | | | |
| | Ketjenblack | | | | |
| | Al-doped | | 3.5 | 3.5 | 3.5 |
| | ZnO | | | | |
| Second | Ga-doped | | | | |
| Conductant | ZnO | | | | |
| | Sb-doped | 4 | | | |
| | SnO₂ | | | | |
| | TiO₂ coated | | | | |
| | with Sb- | | | | |
| | doped SnO₂ | | | | |
| Silicone | Methyl | 0.5 | 0.5 | 0.5 | 0.5 |
| Oil | Phenyl | | | | |
| | Siloxane Oil | | | | |
| Metal Soap | Ca | | 0.5 | 0.5 | 0.5 |
| | Montanate | | | | |
| Additive | Li Stearate | 0.5 | | | |
| Compatibi- | Ethylene- | 3 | 1 | 1 | 1 |
| lizer | Glycidyl | | | | |
| | Acrylate | | | | |
| | Copolymer | | | | |
| | Oxazolines | | | | |
| Thickness | μm | | | | |
| Mechanical | (1) | Good | Good | Good | Good |
| Properties | (2) | Good | Good | Poor | Poor |
| Electrical | (1) | Good | Good | Good | Good |
| Properties | (2) | Good | Good | Good | Good |
| | (3) | Good | Good | Good | Good |
| | (4) | Good | Good | Good | Good |
| | (5) | Poor | Good | Good | Good |
| | (6) | Good | Good | Good | Good |

| | | | | |
|---|---|---|---|---|
| Flame Resistance | Good | Good | Good | Good |
| VTM-0 | | | | |
| Surface Smoothness | Poor | Good | Good | Good |
| Resistivity | Good | Poor | Poor | Poor |
| Controllability | | | | |
| Molding Stability | Good | Good | Good | Good |
| Handle ability | Good | Good | Good | Good |
| Image Evaluation | Poor | Good | Good | Good |

| | | Comparative Examples | | |
|---|---|---|---|---|
| | | 1-13 | 1-14 | 1-15 |
| PPS | T1881-3 | 60 | 20 | 10 |
| | (Toray) | | | |
| | W300 (Poly- | | | |
| | plastics) | | | |
| Si—O-PEI | STM1500 | 40 | 80 | 90 |
| | (SABIC) | | | |
| | STM1700 | | | |
| | (SABIC) | | | |
| First | Acetylene | 11.5 | 12 | 12 |
| Conductant | Black | | | |
| | Ketjenblack | | | |
| Second | Al-doped | 3 | 4 | |
| Conductant | ZnO | | | |
| | Ga-doped | | | |
| | ZnO | | | |
| | Sb-doped | | | |
| | SnO₂ | | | |
| | TiO₂ coated | | | |
| | with Sb- | | | |
| | doped SnO₂ | | | |
| Silicone | Methyl | 0.5 | 0.5 | 0.5 |
| Oil | Phenyl | | | |
| | Siloxane Oil | | | |
| Metal Soap | Ca | | | |
| | Montanate | | | |
| Additive | Li Stearate | 0.5 | 0.5 | 0.5 |
| Compatibi- | Ethylene- | 1 | 1 | 1 |
| lizer | Glycidyl | | | |
| | Acrylate | | | |
| | Copolymer | | | |
| | Oxazolines | | | |
| Thickness | μm | | | |
| Mechanical | (1) | Poor | Poor | Poor |
| Properties | (2) | Poor | Poor | Poor |
| Electrical | (1) | Good | Good | Good |
| Properties | (2) | Good | Good | Good |
| | (3) | Good | Good | Poor |
| | (4) | Good | Good | Poor |
| | (5) | Good | Good | Good |
| | (6) | Good | Good | Good |

| | | | |
|---|---|---|---|
| Flame Resistance | Good | Good | Good |
| VTM-0 | | | |
| Surface Smoothness | Poor | Poor | Poor |
| Resistivity | Poor | Poor | Poor |
| Controllability | | | |
| Molding Stability | Good | Good | Good |
| Handle ability | Good | Good | Good |
| Image Evaluation | Poor | Poor | Poor |

TABLE 2

| | | | Example | | |
|---|---|---|---|---|---|
| | | | 2-1 | 2-2 | 2-3 |
| Silicone- Modified | | STM1500(SABIC) | | 40 | 40 |
| Polyether imide | | STM1700(SABIC) | 95 | 50 | 53 |
| First | PET | Non-reinforced | | | 5 |
| Polymer | | PET(Teijin) | | | |
| | PBT | 1400S(Toray) | | 7 | |
| | 4,6-Nylon | C2000(Teijin) | 5 | | |
| | 6,6-Nylon | CM3001-N(Toray) | | 10 | |
| First Conductant | | Acetylene Black | 9.5 | | |
| | | Ketjenblack | | 4.5 | 4.2 |
| Second Conductant | | Al-doped ZnO | | | |
| (Second Group and | | Ga-doped ZnO | 4 | | 4 |
| Third Group) | | Sb-doped SnO₂ | | 4 | |
| | | TiO₂ coated with | | | |
| | | Sb-doped SnO₂ | | | |
| Additive | Silicone Oil | Methyl Phenyl | | 0.5 | |
| (Fourth | | Siloxane Oil | | | |
| Group) | Metal Soap | Ca Montanate | | 0.5 | |
| | | Li Stearate | | | 0.5 |

| | | | | |
|---|---|---|---|---|
| Compatibilizer | Ethylene-Glycidyl | | | 1 |
| (Fifth Group) | Acrylate Copolymer | | | |
| | Oxazolines | | | |
| Thickness | μm | 85 | 78 | 85 |
| Image Evaluation | Abnormal Image *1 | Good | Good | Good |
| | Durability *2 | Good | Good | Good |
| | Cleanability *3 | Good | Good | Good |
| | Filming *4 | Good | Good | Good |
| Mechanical Properties | (1) | Good | Good | Good |
| | (2) | Good | Good | Good |
| Electrical Properties | (1) | Good | Good | Good |
| | (2) | Good | Good | Good |
| | (3) | Good | Good | Good |
| | (4) | Good | Good | Good |
| | (5) | Good | Good | Good |
| | (6) | Good | Good | Good |

| | | | |
|---|---|---|---|
| Flame Resistance VTM-0 | Good | Good | Good |
| Surface Smoothness | Good | Good | Good |
| Resistivity Controllability | Good | Good | Good |
| Molding Stability | Good | Good | Good |
| Handle ability | Good | Good | Good |

| | | | Example |
|---|---|---|---|
| | | | 2-4 |
| Silicone- Modified | | STM1500(SABIC) | 20 |
| Polyether imide | | STM1700(SABIC) | 75 |
| First | PET | Non-reinforced | 5 |
| Polymer | | PET(Teijin) | |
| | PBT | 1400S(Toray) | |
| | 4,6-Nylon | C2000(Teijin) | |
| | 6,6-Nylon | CM3001-N(Toray) | |
| First Conductant | | Acetylene Black | 5 |
| | | Ketjenblack | 2.5 |
| Second Conductant | | Al-doped ZnO | 3.5 |
| (Second Group and | | Ga-doped ZnO | |
| Third Group) | | Sb-doped SnO₂ | |
| | | TiO₂ coated with | |
| | | Sb-doped SnO₂ | |
| Additive | Silicone Oil | Methyl Phenyl | |
| (Fourth | | Siloxane Oil | |
| Group) | Metal Soap | Ca Montanate | |
| | | Li Stearate | |

| | | |
|---|---|---|
| Compatibilizer | Ethylene-Glycidyl | |
| (Fifth Group) | Acrylate Copolymer | |
| | Oxazolines | 1 |
| Thickness | μm | 87 |
| Image Evaluation | Abnormal Image *1 | Good |
| | Durability *2 | Good |
| | Cleanability *3 | Good |
| | Filming *4 | Good |
| Mechanical Properties | (1) | Good |
| | (2) | Good |
| Electrical Properties | (1) | Good |
| | (2) | Good |
| | (3) | Good |
| | (4) | Good |
| | (5) | Good |
| | (6) | Good |

| | |
|---|---|
| Flame Resistance VTM-0 | Good |
| Surface Smoothness | Good |
| Resistivity Controllability | Good |
| Molding stability | Good |
| Handle ability | Good |

| | | | Comparative Example | | |
|---|---|---|---|---|---|
| | | | 2-1 | 2-2 | 2-3 |
| Silicone- Modified | | STM1500(SABIC) | 50 | 30 | |
| Polyether imide | | STM1700(SABIC) | 50 | 40 | |
| First | PET | Non-reinforced | | | 100 |
| Polymer | | PET(Teijin) | | | |
| | PBT | 1400S(Toray) | | | |
| | 4,6-Nylon | C2000(Teijin) | | | |
| | 6,6-Nylon | CM3001-N(Toray) | | 30 | |
| First Conductant | | Acetylene Black | 10 | | 9.5 |
| | | Ketjenblack | | 4 | |
| Second Conductant | | Al-doped ZnO | | | |
| (Second Group and | | Ga-doped ZnO | | | |
| Third Group) | | Sb-doped SnO₂ | 3 | | 4 |
| | | TiO₂ coated with | | 30 | |
| | | Sb-doped SnO₂ | | | |
| Additive | Silicone Oil | Methyl Phenyl | 1 | | |
| (Fourth | | Siloxane Oil | | | |
| Group) | Metal Soap | Ca Montanate | | | 0.5 |
| | | Li Stearate | | | |
| Compatibilizer | | Ethylene-Glycidyl | 0.5 | | |
| (Fifth Group) | | Acrylate Copolymer | | | |
| | | Oxazolines | | | |
| Thickness | | μm | 88 | 85 | 90 |
| Image Evaluation | | Abnormal Image *1 | Good | Good | Good |
| | | Durability *2 | Good | Poor | Good |
| | | Cleanability *3 | Good | Poor | Poor |
| | | Filming *4 | Good | Poor | Poor |
| Mechanical Properties | | (1) | Good | Poor | Good |
| | | (2) | Poor | Good | Good |
| Electrical Properties | | (1) | Good | Good | Good |
| | | (2) | Good | Good | Good |
| | | (3) | Good | Good | Good |
| | | (4) | Good | Good | Good |
| | | (5) | Good | Good | Good |
| | | (6) | Good | Good | Good |
| Flame Resistance VTM-0 | | | Good | Poor | Poor |
| Surface Smoothness | | | Good | Poor | Good |
| Resistivity Controllability | | | Good | Good | Good |
| Molding Stability | | | Good | Good | Good |
| Handle ability | | | Good | Good | Good |
| | | | Comparative Example | | |
| | | | 2-4 | 2-5 | 2-6 |
| Silicone- Modified | | STM1500(SABIC) | | | |
| Polyether imide | | STM1700(SABIC) | | | |
| First | PET | Non-reinforced | | | |
| Polymer | | PET(Teijin) | | | |
| | PBT | 1400S(Toray) | 100 | | |
| | 4,6-Nylon | C2000(Teijin) | | | 100 |
| | 6,6-Nylon | CM3001-N(Toray) | | 100 | |
| First Conductant | | Acetylene Black | 9.5 | 9.5 | 9.5 |
| | | Ketjenblack | | | |
| Second Conductant | | Al-doped ZnO | | | |
| (Second Group and | | Ga-doped ZnO | | | |
| Third Group) | | Sb-doped SnO₂ | 4 | 4 | 4 |
| | | TiO₂ coated with | | | |
| | | Sb-doped SnO₂ | | | |
| Additive | Silicone Oil | Methyl Phenyl | | | |
| (Fourth | | Siloxane Oil | | | |
| Group) | Metal Soap | Ca Montanate | 0.5 | 0.5 | 0.5 |
| | | Li Stearate | | | |

| | | | | |
|---|---|---|---|---|
| Compatibilizer | Ethylene-Glycidyl | | | |
| (Fifth Group) | Acrylate Copolymer | | | |
| | Oxazolines | | | |
| Thickness | μm | 90 | 95 | 87 |
| Image Evaluation | Abnormal Image *1 | Good | Good | Good |
| | Durability *2 | Good | Good | Good |
| | Cleanability *3 | Poor | Poor | Poor |
| | Filming *4 | Poor | Poor | Poor |
| Mechanical Properties | (1) | Good | Good | Good |
| | (2) | Good | Good | Good |
| Electrical Properties | (1) | Good | Good | Good |
| | (2) | Good | Good | Good |
| | (3) | Good | Good | Good |
| | (4) | Good | Good | Good |
| | (5) | Good | Good | Good |
| | (6) | Good | Good | Good |

| | | | |
|---|---|---|---|
| Flame Resistance VTM-0 | Poor | Poor | Poor |
| Surface Smoothness | Good | Good | Good |
| Resistivity Controllability | Good | Good | Good |
| Molding Stability | Good | Good | Good |
| Handle ability | Good | Good | Good |

| | | | Comparative |
|---|---|---|---|
| | | | Example |
| Silicone- Modified | | STM1500(SABIC) | |
| Polyether imide | | STM1700(SABIC) | 70 |
| First | PET | Non-reinforced | |
| Polymer | | PET(Teijin) | |
| | PBT | 1400S(Toray) | |
| | 4,6-Nylon | C2000(Teijin) | 30 |
| | 6,6-Nylon | CM3001-N(Toray) | |
| First Conductant | | Acetylene Black | |
| | | Ketjenblack | 4 |
| Second Conductant | | Al-doped ZnO | |
| (Second Group and | | Ga-doped ZnO | |
| Third Group) | | Sb-doped SnO₂ | |
| | | TiO₂ coated with | 4 |
| | | Sb-doped SnO₂ | |
| Additive | Silicone Oil | Methyl Phenyl | |
| (Fourth | | Siloxane Oil | |
| Group) | Metal Soap | Ca Montanate | |
| | | Li Stearate | 0.5 |

| | | |
|---|---|---|
| Compatibilizer | Ethylene-Glycidyl | |
| (Fifth Group) | Acrylate Copolymer | |
| | Oxazolines | |
| Thickness | μm | 95 |
| Image Evaluation | Abnormal Image *1 | Good |
| | Durability *2 | Poor |
| | Cleanability *3 | Poor |
| | Filming *4 | Poor |
| Mechanical Properties | (1) | Poor |
| | (2) | Good |
| Electrical Properties | (1) | Good |
| | (2) | Good |
| | (3) | Good |
| | (4) | Good |
| | (5) | Good |
| | (6) | Good |

| | |
|---|---|
| Flame Resistance VTM-0 | Poor |
| Surface Smoothness | Poor |
| Resistivity Controllability | Good |
| Molding stability | Good |
| Handle ability | Good |

*1: No white spots, no scattered image and no void image
*2: No crack for not less than 240 kp
*3: No defective cleaning
*4: Initial If is 10 mA or less and If increases by 150% or less after 10 kp

TABLE 3

| | | | Example | | |
|---|---|---|---|---|---|
| | | | 3-1 | 3-2 | 3-3 |
| Base | Silicone-Modified | STM150 | 80 | 70 | 80 |
| Polymer | polyether imide | | | | |
| First | PEI | Ultem 1000-1000 | 20 | 30 | 20 |
| Polymer | PES | Sumica Excel | | | |
| | | 3600P | | | |
| First | Carbon | Acetylene Black | 11.5 | 11.5 | |
| Conductant | | Ketjenblack | | | 9 |
| Second | Second and | Al-doped ZnO | | | |
| Conductant | Third group | Ga-doped ZnO | | | |
| | Conductant | Sb-doped SnO₂ | | | |
| | | TiO₂ coated with | | | |
| | | Sb-doped SnO₂ | | | |
| Additive | Silicone Oil | Methyl Phenyl | | | |
| | | Siloxane Oil | | | |
| | Metal Soap | Ca Montanate | | | |
| | | Li Stearate | | | |
| Additive | Compatibilizer | Ethylene-Glycidyl | | | |
| | | Acrylate | | | |
| | | Copolymer | | | |
| | | Oxazolines | | | |
| Properties | Thickness | μm | 88 ± 10 | 92 ± 10 | 86 ± 10 |
| | Uneven | % | 93 | 90 | 88 |
| | Distribution | | | | |
| | of Carbon | | | | |
| | Mechanical | (1) | Good | Good | Good |
| | Properties | (2) | Good | Good | Good |
| | Electrical | (1) | Good | Good | Good |
| | Properties | (2) | Good | Good | Good |
| | | (3) | Good | Good | Good |
| | | (4) | Good | Good | Good |
| | | (5) | Good | Good | Good |
| | | (6) | Good | Good | Good |
| | Flame Resistance VTM-0 | | Good | Good | Good |
| | Surface Smoothness | | Good | Good | Good |
| | Resistivity Controllability | | Good | Good | Good |
| | Molding Stability | | Good | Good | Good |
| | Handle ability | | Good | Good | Good |
| | Image Evaluation | | Good | Good | Good |
| | | | Example | | |
| | | | 3-4 | 3-5 | 3-6 |
| Base | Silicone-Modified | STM150 | 80 | 80 | 80 |
| Polymer | polyether imide | | | | |
| First | PEI | Ultem 1000-1000 | 20 | 20 | 20 |
| Polymer | PES | Sumica Excel | | | |
| | | 3600P | | | |
| First | Carbon | Acetylene Black | 11.5 | 11.5 | 11.5 |
| Conductant | | Ketjenblack | | | |
| Second | Second and | Al-doped ZnO | 4 | | |
| Conductant | Third group | Ga-doped ZnO | | 4 | |
| | Conductant | Sb-doped SnO₂ | | | 4 |
| | | TiO₂ coated with | | | |
| | | Sb-doped SnO₂ | | | |
| Additive | Silicone Oil | Methyl Phenyl | | | |
| | | Siloxane Oil | | | |
| | Metal Soap | Ca Montanate | | | |
| | | Li Stearate | | | |
| Additive | Compatibilizer | Ethylene-Glycidyl | | | |
| | | Acrylate | | | |
| | | Copolymer | | | |
| | | Oxazolines | | | |
| Properties | Thickness | μm | 90 ± 10 | 86 ± 10 | 88 ± 10 |
| | Uneven | % | 91 | 88 | 85 |
| | Distribution | | | | |
| | of Carbon | | | | |
| | Mechanical | (1) | Good | Good | Good |
| | Properties | (2) | Good | Good | Good |
| | Electrical | (1) | Good | Good | Good |
| | Properties | (2) | Good | Good | Good |
| | | (3) | Good | Good | Good |
| | | (4) | Good | Good | Good |
| | | (5) | Good | Good | Good |
| | | (6) | Good | Good | Good |
| | Flame Resistance VTM-0 | | Good | Good | Good |
| | Surface Smoothness | | Good | Good | Good |
| | Resistivity Controllability | | Good | Good | Good |
| | Molding Stability | | Good | Good | Good |
| | Handle ability | | Good | Good | Good |
| | Image Evaluation | | Good | Good | Good |
| | | | Example | | |
| | | | 3-7 | 3-8 | 3-9 |
| Base | Silicone-Modified | STM150 | 80 | 80 | 80 |
| Polymer | polyether imide | | | | |
| First | PEI | Ultem 1000-1000 | 20 | 20 | 20 |
| Polymer | PES | Sumica Excel | | | |
| | | 3600P | | | |
| First | Carbon | Acetylene Black | 11.5 | 11.5 | 11.5 |
| Conductant | | Ketjenblack | | | |
| Second | Second and | Al-doped ZnO | | 4 | 4 |
| Conductant | Third group | Ga-doped ZnO | | | |
| | Conductant | Sb-doped SnO₂ | | | |
| | | TiO₂ coated with | 4 | | |
| | | Sb-doped SnO₂ | | | |
| Additive | Silicone Oil | Methyl Phenyl | | 0.5 | |
| | | Siloxane Oil | | | |
| | Metal Soap | Ca Montanate | | | 0.5 |
| | | Li Stearate | | | |
| Additive | Compatibilizer | Ethylene-Glycidyl | | | |
| | | Acrylate | | | |
| | | Copolymer | | | |
| | | Oxazolines | | | |
| Properties | Thickness | μm | 89 ± 10 | 91 ± 10 | 86 ± 10 |
| | Uneven | % | 87 | 90 | 81 |
| | Distribution | | | | |
| | of Carbon | | | | |
| | Mechanical | (1) | Good | Good | Good |
| | Properties | (2) | Good | Good | Good |
| | Electrical | (1) | Good | Good | Good |
| | Properties | (2) | Good | Good | Good |
| | | (3) | Good | Good | Good |
| | | (4) | Good | Good | Good |
| | | (5) | Good | Good | Good |
| | | (6) | Good | Good | Good |
| | Flame Resistance VTM-0 | | Good | Good | Good |
| | Surface Smoothness | | Good | Good | Good |
| | Resistivity Controllability | | Good | Good | Good |
| | Molding Stability | | Good | Good | Good |
| | Handle ability | | Good | Good | Good |
| | Image Evaluation | | Good | Good | Good |
| | | | Example | | |
| | | | 3-10 | 3-11 | 3-12 |
| Base | Silicone-Modified | STM150 | 80 | 80 | 80 |
| Polymer | polyether imide | | | | |
| First | PEI | Ultem 1000-1000 | 20 | 20 | 20 |
| Polymer | PES | Sumica Excel | | | |
| | | 3600P | | | |
| First | Carbon | Acetylene Black | 11.5 | 11.5 | 11.5 |
| Conductant | | Ketjenblack | | | |
| Second | Second and | Al-doped ZnO | 4 | 4 | 4 |
| Conductant | Third group | Ga-doped ZnO | | | |
| | Conductant | Sb-doped SnO₂ | | | |
| | | TiO₂ coated with | | | |
| | | Sb-doped SnO₂ | | | |
| Additive | Silicone Oil | Methyl Phenyl | | 0.5 | 0.5 |
| | | Siloxane Oil | | | |
| | Metal Soap | Ca Montanate | | | |
| | | Li Stearate | 0.5 | | |
| Additive | Compatibilizer | Ethylene-Glycidyl | | 0.5 | |
| | | Acrylate | | | |
| | | Copolymer | | | |
| | | Oxazolines | | | 0.5 |
| Properties | Thickness | μm | 85 ± 10 | 88 ± 10 | 92 ± 10 |
| | Uneven | % | 84 | 82 | 86 |
| | Distribution | | | | |
| | of Carbon | | | | |
| | Mechanical | (1) | Good | Good | Good |
| | Properties | (2) | Good | Good | Good |
| | Electrical | (1) | Good | Good | Good |
| | Properties | (2) | Good | Good | Good |
| | | (3) | Good | Good | Good |
| | | (4) | Good | Good | Good |
| | | (5) | Good | Good | Good |
| | | (6) | Good | Good | Good |

| | | | |
|---|---|---|---|
| Flame Resistance VTM-0 | Good | Good | Good |
| Surface Smoothness | Good | Good | Good |
| Resistivity Controllability | Good | Good | Good |
| Molding Stability | Good | Good | Good |
| Handle ability | Good | Good | Good |
| Image Evaluation | Good | Good | Good |

| | | | Example |
|---|---|---|---|
| | | | 3-13 |
| Base | Silicone-Modified | STM150 | 80 |
| Polymer | polyether imide | | |
| First | PEI | Ultem 1000-1000 | 20 |
| Polymer | PES | Sumica Excel | |
| | | 3600P | |
| First | Carbon | Acetylene Black | 11.5 |
| Conductant | | Ketjenblack | |
| Second | Second and | Al-doped ZnO | 4 |
| Conductant | Third group | Ga-doped ZnO | |
| | Conductant | Sb-doped SnO₂ | |
| | | TiO₂ coated with | |
| | | Sb-doped SnO₂ | |
| Additive | Silicone Oil | Methyl Phenyl | 0.5 |
| | | Siloxane Oil | |
| | Metal Soap | Ca Montanate | |
| | | Li Stearate | |
| Additive | Compatibilizer | Ethylene-Glycidyl | 0.5 |
| | | Acrylate | |
| | | Copolymer | |
| | | Oxazolines | |
| Properties | Thickness | μm | 94 ± 10 |
| | Uneven | % | 88 |
| | Distribution | | |
| | of Carbon | | |
| | Mechanical | (1) | Good |
| | Properties | (2) | Good |
| | Electrical | (1) | Good |
| | Properties | (2) | Good |
| | | (3) | Good |
| | | (4) | Good |
| | | (5) | Good |
| | | (6) | Good |

| | |
|---|---|
| Flame Resistance VTM-0 | Good |
| Surface Smoothness | Good |
| Resistivity Controllability | Good |
| Molding Stability | Good |
| Handle ability | Good |
| Image Evaluation | Good |

| | | | Comparative Example | | |
|---|---|---|---|---|---|
| | | | 3-1 | 3-2 | 3-3 |
| Base | Silicone- | STM150 | 98 | 55 | 98 |
| Polymer | Modified | | | | |
| | polyether imide | | | | |
| First | PEI | Ultem 1000-1000 | 2 | 45 | 2 |
| Polymer | PES | Sumica Excel | | | |
| | | 3600P | | | |
| First | Carbon | Acetylene Black | 11.5 | 11.5 | |
| Conductant | | Ketjenblack | | | 9 |
| Second | Second and | Al-doped ZnO | | | |
| Conductant | Third group | Ga-doped ZnO | | | |
| | Conductant | Sb-doped SnO₂ | | | |
| | | TiO₂ coated with | | | |
| | | Sb-doped SnO₂ | | | |
| Additive | Silicone Oil | Methyl Phenyl | | | |
| | | Siloxane Oil | | | |
| | Metal Soap | Ca Montanate | | | |
| | | Li Stearate | | | |
| Additive | Compatibilizer | Ethylene-Glycidyl | | | |
| | | Acrylate | | | |
| | | Copolymer | | | |
| | | Oxazolines | | | |
| Properties | Thickness | μm | 90 ± 10 | 86 ± 1 | 91 ± 10 |
| | Uneven | % | 31 | 47 | 46 |
| | Distribution | | | | |
| | of Carbon | | | | |
| | Mechanical | (1) | Poor | Good | Poor |
| | Properties | (2) | Good | Good | Poor |
| | Electrical | (1) | Poor | Poor | Good |
| | Properties | (2) | Poor | Poor | Poor |
| | | (3) | Poor | Good | Good |
| | | (4) | Poor | Good | Good |
| | | (5) | Good | Good | Good |
| | | (6) | Good | Good | Good |
| | Flame Resistance VTM-0 | | Good | Good | Good |
| | Surface Smoothness | | Good | Good | Good |
| | Resistivity Controllability | | Poor | Poor | Poor |
| | Molding Stability | | Poor | Good | Good |
| | Handle ability | | Poor | Poor | Good |
| | Image Evaluation | | Poor | Poor | Poor |
| | | | Comparative Example | | |
| | | | 3-4 | 3-5 | 3-6 |
| Base | Silicone- | STM150 | 55 | 80 | 80 |
| Polymer | Modified | | | | |
| | polyether imide | | | | |
| First | PEI | Ultem 1000-1000 | 45 | 20 | 20 |
| Polymer | PES | Sumica Excel | | | |
| | | 3600P | | | |
| First | Carbon | Acetylene Black | | 11.5 | 11.5 |
| Conductant | | Ketjenblack | 9 | | |
| Second | Second and | Al-doped ZnO | | 4 | |
| Conductant | Third group | Ga-doped ZnO | | | 4 |
| | Conductant | Sb-doped SnO₂ | | | |
| | | TiO₂ coated with | | | |
| | | Sb-doped SnO₂ | | | |
| Additive | Silicone Oil | Methyl Phenyl | | | |
| | | Siloxane Oil | | | |
| | Metal Soap | Ca Montanate | | | |
| | | Li Stearate | | | |
| Additive | Compatibilizer | Ethylene-Glycidyl | | | |
| | | Acrylate | | | |
| | | Copolymer | | | |
| | | Oxazolines | | | |
| Properties | Thickness | μm | 91 ± 10 | 88 ± 10 | 86 ± 10 |
| | Uneven | % | 51 | 51 | 38 |
| | Distribution | | | | |
| | of Carbon | | | | |
| | Mechanical | (1) | Good | Good | Good |
| | Properties | (2) | Good | Good | Good |
| | Electrical | (1) | Good | Good | Good |
| | Properties | (2) | Poor | Good | Good |
| | | (3) | Good | Good | Good |
| | | (4) | Good | Good | Good |
| | | (5) | Good | Good | Good |
| | | (6) | Good | Good | Good |
| | Flame Resistance VTM-0 | | Good | Good | Good |
| | Surface Smoothness | | Good | Poor | Poor |
| | Resistivity Controllability | | Poor | Good | Good |
| | Molding Stability | | Good | Good | Good |
| | Handle ability | | Good | Good | Good |
| | Image Evaluation | | Poor | Poor | Poor |
| | | | Comparative Example | | |
| | | | 3-7 | 3-8 | 3-9 |
| Base | Silicone- | STM150 | 80 | 80 | 80 |
| Polymer | Modified | | | | |
| | polyether imide | | | | |
| First | PEI | Ultem 1000-1000 | 20 | 20 | 20 |
| Polymer | PES | Sumica Excel | | | |
| | | 3600P | | | |
| First | Carbon | Acetylene Black | 11.5 | 11.5 | 11.5 |
| Conductant | | Ketjenblack | | | |
| Second | Second and | Al-doped ZnO | | | 4 |
| Conductant | Third group | Ga-doped ZnO | | | |
| | Conductant | Sb-doped SnO₂ | 4 | | |
| | | TiO₂ coated with | | 4 | |
| | | Sb-doped SnO₂ | | | |
| Additive | Silicone Oil | Methyl Phenyl | | | 3 |
| | | Siloxane Oil | | | |
| | Metal Soap | Ca Montanate | | | |
| | | Li Stearate | | | |
| Additive | Compatibilizer | Ethylene-Glycidyl | | | |
| | | Acrylate | | | |
| | | Copolymer | | | |
| | | Oxazolines | | | |
| Properties | Thickness | μm | 89 ± 10 | 92 ± 10 | 90 ± 10 |
| | Uneven | % | 37 | 34 | 36 |
| | Distribution | | | | |
| | of Carbon | | | | |
| | Mechanical | (1) | Good | Good | Good |
| | Properties | (2) | Good | Good | Good |
| | Electrical | (1) | Good | Good | Good |
| | Properties | (2) | Good | Good | Good |
| | | (3) | Good | Good | Good |
| | | (4) | Good | Good | Good |
| | | (5) | Good | Good | Poor |
| | | (6) | Good | Good | Good |
| | Flame Resistance VTM-0 | | Good | Good | Good |
| | Surface Smoothness | | Poor | Poor | Poor |
| | Resistivity Controllability | | Good | Good | Good |
| | Molding Stability | | Good | Good | Good |
| | Handle ability | | Good | Good | Good |
| | Image Evaluation | | Poor | Poor | Poor |
| | | | Comparative Example | | |
| | | | 3-10 | 3-11 | 3-12 |
| Base | Silicone- | STM150 | 80 | 80 | 80 |
| Polymer | Modified | | | | |
| | polyether imide | | | | |
| First | PEI | Ultem 1000-1000 | 20 | 20 | 20 |
| Polymer | PES | Sumica Excel | | | |
| | | 3600P | | | |
| First | Carbon | Acetylene Black | 11.5 | 11.5 | 11.5 |
| Conductant | | Ketjenblack | | | |
| Second | Second and | Al-doped ZnO | 4 | 4 | 4 |
| Conductant | Third group | Ga-doped ZnO | | | |
| | Conductant | Sb-doped SnO₂ | | | |
| | | TiO₂ coated with | | | |
| | | Sb-doped SnO₂ | | | |
| Additive | Silicone Oil | Methyl Phenyl | | | 3 |
| | | Siloxane Oil | | | |
| | Metal Soap | Ca Montanate | 3. | | |
| | | Li Stearate | | 3 | |
| Additive | Compatibilizer | Ethylene-Glycidyl | | | 3 |
| | | Acrylate | | | |
| | | Copolymer | | | |
| | | Oxazolines | | | |
| Properties | Thickness | μm | 88 ± 10 | 91 ± 10 | 91 ± 10 |
| | Uneven | % | 42 | 37 | 51 |
| | Distribution | | | | |
| | of Carbon | | | | |
| | Mechanical | (1) | Good | Good | Good |
| | Properties | (2) | Good | Poor | Poor |
| | Electrical | (1) | Good | Good | Good |
| | Properties | (2) | Good | Good | Good |
| | | (3) | Good | Good | Good |
| | | (4) | Good | Good | Good |
| | | (5) | Good | Good | Good |
| | | (6) | Good | Good | Good |
| | Flame Resistance VTM-0 | | Good | Good | Good |
| | Surface Smoothness | | Poor | Poor | Poor |
| | Resistivity Controllability | | Poor | Poor | Poor |
| | Molding Stability | | Good | Good | Good |
| | Handle ability | | Good | Good | Good |
| | Image Evaluation | | Poor | Poor | Poor |
| | | | Comparative Example | | |
| | | | 3-13 | 3-14 | 3-15 |
| Base | Silicone- | STM150 | 80 | 98 | 55 |
| Polymer | Modified | | | | |
| | polyether imide | | | | |
| First | PEI | Ultem 1000-1000 | 20 | 2 | 45 |
| Polymer | PES | Sumica Excel | | | |
| | | 3600P | | | |
| First | Carbon | Acetylene Black | 11.5 | 11.5 | 11.5 |
| Conductant | | Ketjenblack | | | |
| Second | Second and | Al-doped ZnO | 4 | 4 | 4 |
| Conductant | Third group | Ga-doped ZnO | | | |
| | Conductant | Sb-doped SnO₂ | | | |
| | | TiO₂ coated with | | | |
| | | Sb-doped SnO₂ | | | |
| Additive | Silicone Oil | Methyl Phenyl | 3 | 3 | 3 |
| | | Siloxane Oil | | | |
| | Metal Soap | Ca Montanate | | | |
| | | Li Stearate | | | |
| Additive | Compatibilizer | Ethylene-Glycidyl | | 3 | 3 |
| | | Acrylate | | | |
| | | Copolymer | | | |
| | | Oxazolines | 3 | | |
| Properties | Thickness | μm | 93 ± 10 | 91 ± 10 | 89 ± 10 |
| | Uneven | % | 48 | 51 | 46 |
| | Distribution | | | | |
| | of Carbon | | | | |
| | Mechanical | (1) | Poor | Poor | Poor |
| | Properties | (2) | Poor | Poor | Poor |
| | Electrical | (1) | Good | Poor | Poor |
| | Properties | (2) | Good | Poor | Poor |
| | | (3) | Good | Good | Good |
| | | (4) | Good | Good | Good |
| | | (5) | Good | Good | Good |
| | | (6) | Good | Good | Good |

| | | | |
|---|---|---|---|
| Flame Resistance VTM-0 | Good | Good | Good |
| Surface Smoothness | Poor | Good | Good |
| Resistivity Controllability | Poor | Good | Good |
| Molding Stability | Good | Good | Good |
| Handle ability | Good | Good | Good |
| Image Evaluation | Poor | Poor | Poor |

TABLE 4

| | | Example 4-1 | Example 4-2 | Example 4-3 | Example 4-4 |
|---|---|---|---|---|---|
| semi-aromatic | | 100 | 97 | 60 | 95 |
| crystalline thermoplastic | | | | | |
| PI | | | | | |
| PEI | Ultem1000- | | 3 | 40 | 5 |
| | 1000(SABIC) | | | | |
| Thermoplastic | Torlon4200 | | | | |
| PAI | (SOLVAY) | | | | |
| PES | 3600P | | | | |
| | (Mitsubishi | | | | |
| | Chemical) | | | | |
| LCP | RB110 | | | | |
| | (Sumitomo | | | | |
| | Chemical) | | | | |
| Conductant | Acetylene | 12 | | | |
| | Black | | | | |
| | Ketjenblack | | 4.5 | 4.5 | 3.5 |
| | Large-Size | | | | |
| | Carbon | | | | |
| Thickness (μm) | | 90 | 88 | 91 | 93 |
| Carbon Presence | | Dispersion | Dispersion | Dispersion | Dispersion |
| | | Phase | Phase | Phase | Phase |
| Mechanical | (1) | Good | Good | Good | Good |
| Properties | (2) | Good | Good | Good | Good |
| Electrical | (1) | Good | Good | Good | Good |
| Properties | (2) | Good | Good | Good | Good |
| | (3) | Good | Good | Good | Good |
| | (4) | Good | Good | Good | Good |
| | (5) | Good | Good | Good | Good |
| | (6) | Good | Good | Good | Good |
| Surface Smoothness | | Good | Good | Good | Good |
| Resistivity Controllability | | Good | Good | Good | Good |
| Molding Stability | | Good | Good | Good | Good |
| Handle ability | | Good | Good | Good | Good |
| Image Evaluation | | Good | Good | Good | Good |
| | | | | | Comparative |
| | | Example 4-5 | Example 4-6 | Example 4-7 | Example 4-1 |
| semi-aromatic | | 97 | 60 | 95 | 55 |
| crystalline thermoplastic | | | | | |
| PI | | | | | |
| PEI | Ultem1000- | | | | 45 |
| | 1000(SABIC) | | | | |
| Thermoplastic | Torlon4200 | 3 | 40 | 5 | |
| PAI | (SOLVAY) | | | | |
| PES | 3600P | | | | |
| | (Mitsubishi | | | | |
| | Chemical) | | | | |
| LCP | RB110 | | | | |
| | (Sumitomo | | | | |
| | Chemical) | | | | |
| Conductant | Acetylene | | | | |
| | Black | | | | |
| | Ketjenblack | 45 | 4.5 | 3.5 | 4.5 |
| | Large-Size | | | 1 | |
| | Carbon | | | | |
| Thickness (μm) | | 90 | 89 | 92 | 87 |
| Carbon Presence | | Dispersion | Dispersion | Dispersion | Dispersion |
| | | Phase | Phase | Phase | Phase |
| Mechanical | (1) | Good | Good | Good | Poor |
| Properties | (2) | Good | Good | Good | Good |
| Electrical | (1) | Good | Good | Good | Good |
| Properties | (2) | Good | Good | Good | Good |
| | (3) | Good | Good | Good | Poor |
| | (4) | Good | Good | Good | Poor |
| | (5) | Good | Good | Good | Good |
| | (6) | Good | Good | Good | Good |

| | | | | |
|---|---|---|---|---|
| Surface Smoothness | Good | Good | Good | Poor |
| Resistivity Controllability | Good | Good | Good | Good |
| Molding Stability | Good | Good | Good | Good |
| Handle ability | Good | Good | Good | Good |
| Image Evaluation | Good | Good | Good | Poor |
| Molding Stability | Good | Poor | Poor | Good |
| Handle ability | Good | Good | Good | Good |
| Image Evaluation | Poor | Poor | Poor | Poor |

| | | Comparative |
|---|---|---|
| | | Example 4-6 |
| semi-aromatic | | 90 |
| crystalline thermoplastic | | |
| PI | | |
| PEI | Ultem1000- | |
| | 1000(SABIC) | |
| Thermoplastic | Torlon4200 | |
| PAI | (SOLVAY) | |
| PES | 3600P | |
| | (Mitsubishi | |
| | Chemical) | |
| LCP | RB110 | 10 |
| | (Sumitomo | |
| | Chemical) | |
| Conductant | Acetylene | 12 |
| | Black | |
| | Ketjenblack | |
| | Large-Size | |
| | Carbon | |
| Thickness (μm) | | 88 |
| Carbon Presence | | Continuous |
| | | Phase |
| Mechanical | (1) | Good |
| Properties | (2) | Good |
| Electrical | (1) | Good |
| Properties | (2) | Good |
| | (3) | Poor |
| | (4) | Poor |
| | (5) | Good |
| | (6) | Good |

| | |
|---|---|
| Surface Smoothness | Poor |
| Resistivity Controllability | Good |
| Molding Stability | Good |
| Handle ability | Good |
| Image Evaluation | Poor |

Having now fully described the invention, it will be apparent to one of ordinary skill in the art that many changes and modifications can be made thereto without departing from the spirit and scope of the invention as set forth therein.

What is claimed is:

1. An electroconductive resin belt, comprising:
a first resin selected from a first group consisting of polyetherimide-siloxane block copolymer, polyphenylene sulfide and polyimide;
a second resin selected from a second group consisting of polyetherimide, polyether sulfone, polyester, aliphatic polyamide, polyetherimide-siloxane block copolymer and polyamideimide;
carbon as a first conductant; and
at least one second conductant selected from a third group consisting of particulate Al-doped ZnO, particulate Ga-doped ZnO, particulate Sb-doped SnO₂, particulate In-doped SnO₂, particulate P-doped SnO₂ and a fourth group consisting of metal oxides coated with any one of the members of the third group,
wherein the first resin forms a continuous phase, the second resin forms a dispersion phase, the carbon is unevenly distributed in the dispersion phase or an arc therearound, the second conductant is present in both of the dispersion phase and the continuous phase, and the belt has a flame resistance of VTM-0 in UL94 standard when having a thickness of from 50 to 150 μm.

2. The electroconductive resin belt of claim 1, further comprising at least one additive selected from a fifth group consisting of silicone oil, metal soap, particulate polyimide and particulate silicone, wherein the additive forms a second dispersion phase.

3. The electroconductive resin belt of claim 1, further comprising at least one compatibilizer selected from a sixth group consisting of an ethylene-glycidyl methacrylate copolymer and a polymer including an oxazoline group in an amount of from 0.1 to 2.0 parts by weight based on total weight of the first and the second resins.

4. The electroconductive resin belt of claim 1, wherein the first resin is a polyphenylene sulfide resin and the second resin is a polyetherimide-siloxane block copolymer resin (Si-O-PEI).

5. The electroconductive resin belt of claim 1, wherein the first resin is a polyetherimide-siloxane block copolymer resin (Si-O-PEI) and the second resin is at least one of polyester and aliphatic polyamide.

6. The electroconductive resin belt of claim 1, wherein the first resin is a polyetherimide-siloxane block copolymer resin (Si-O-PEI) and the second resin is at least one of polyetherimide and polyether sulfone.

7. The electroconductive resin belt of claim 1, wherein the first resin is a semi-aromatic crystalline thermoplastic polyimide having a melting point not higher than 360° C., and the second resin is at least one of polyetherimide and thermoplastic polyamideimide.

8. The electroconductive resin belt of claim 1, wherein the second resin is included in an amount not greater than 10% by weight per 100% by weight of the first resin, and the carbon as the first conductant is included less than the second resin.

9. The electroconductive resin belt of claim 1, wherein the first and the second conductants have an average primary particle diameter not greater than 100 nm.

10. The electroconductive resin belt of claim 2, wherein the additive selected from the fifth group is included in an amount of from 0.1 to 2.0% by weight.

11. The electroconductive resin belt of claim 3, wherein the at least one compatibilizer selected from the sixth group is included in an amount of from 0.1 to 2.0% by weight, and preferably from 0.2 to 1.0% by weight per 100% by weight of the first and the second resins.

12. The electroconductive resin belt of claim 1, wherein the belt has a volume resistivity at 100 V (Rv100 [Ω·cm]) of from 10⁸ to 10¹² [Ω·cm] and a surface resistivity of from at 500 V (Rv500 [Ω·cm]) of from 10⁸ to 10¹² [Ω/□].

13. A method of preparing the electroconductive resin belt according to claim 1, comprising:
pulverizing the first and the second resins to form particles having an average particle diameter not greater than 300 μm;
stirring the particles, carbon as a first conductant and at least one second conductant selected from the third and the fourth groups at a high speed of from 1,000 to 3,000 rpm to form a mixture;
melting and kneading the mixture at from 260 to 330° C. to prepare a melted and kneaded mixture; and
molding the melted and kneaded mixture by extrusion.

14. The method of claim 13, wherein the step of stirring the particles, the first conductant and the second conductant at a high speed of from 1,000 to 3,000 rpm further stirring at least one additive selected from the fifth group or at least one additive selected from the fifth group and at least one compatibilizer selected from the six group.

15. The method of claim 13, wherein the step of molding the melted and kneaded mixture further comprising:
cooling the mixture to have a temperature not higher than a glass transition temperature thereof with a mandrel located at the bottom of a die.

16. An image forming apparatus, comprising:
an electrostatic latent image former configured to form an electrostatic latent image on an image bearer;
an image developer configured to develop the electrostatic latent image on an image bearer formed on the image bearer with a toner to form a toner image;
a first transferer configured to transfer the toner image on the image bearer onto the electroconductive resin belt according to claim 1;
a second transferer configured to transfer the toner image on the electroconductive resin belt onto a recording medium; and
a fixer configured to fix the toner image on the recording medium.

17. An image forming apparatus, comprising:
an electrostatic latent image former configured to form an electrostatic latent image on an image bearer;
an image developer configured to develop the electrostatic latent image on an image bearer formed on the image bearer with a toner to form a toner image;
the electroconductive resin belt according to claim 1 configured to transfer the toner image on the image bearer onto a recording medium; and
a fixer configured to fix the toner image on the recording medium.
